(19) United States
(12) Patent Application Publication
(10) Pub. No.: US 2009/0037975 A1
(43) Pub. Date: Feb. 5, 2009

(54) System and Method for Authenticating Content

(76) Inventors: Mark M. Ishikawa, Los Gatos, CA (US); Lawrence Low, San Francisco, CA (US); Travis Hill, Provo, UT (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/127,541

(22) Filed: May 27, 2008

Related U.S. Application Data
(60) Provisional application No. 60/952,763, filed on Jul. 30, 2007.

(51) Int. Cl. G06F 21/00

(52) U.S. Cl. 726/1

(57) ABSTRACT

A system for authenticating content and methods for making and using same. The content authentication system advantageously facilitates recognition of known content, control over use of the known content, and knowledge accumulation regarding the use of known content for monetization models. The recognition of the suspect content preferably includes an analysis of known content recognition data associated with the known content and suspect content recognition data associated with the suspect content. A correlation between the known content recognition data and the suspect content recognition data is found, and the suspect content is analyzed in light of the correlation and known content rules associated with the known content. Thereby, the content authentication system can determine whether to approve action for the suspect content. The content authentication system enables selected known content information to be shared among known content right holders and hosting websites.

### CROSS REFERENCE TO RELATED APPLICATIONS

This application claims priority to a U.S. provisional patent application Ser. No. 60/952,763, filed Jul. 30, 2007. Priority to the provisional application is expressly claimed, and the disclosure of the provisional application is hereby incorporated herein by reference in its entirety.

### BACKGROUND

With the advent of the internet and other wide area networks, people have been able to share many different types of information with increased ease. Unfortunately, some use the internet as a tool for sharing information or data that is not owned by them. Intellectual property right misappropriation, including copyright infringement via the Internet, has become a major hurdle in the overall protection, and rightful use, exploitation, and commercialization of intellectual property rights throughout the world. To protect their rights effectively and profit from them at a great extent, intellectual property right holders should be able to efficiently and accurately detect infringement of their intellectual property that occurs via a network, the Internet, or the World Wide Web (“WWW”).

Although some of the distributed information is public information or information considered to be within the public domain, other information that is being distributed is not within the public domain, but rather, is privately owned. In these instances, the rights of the owners of this information is being violated. Indeed, the unauthorized distribution of materials or contents, such as photographs, videos, movies, music, and articles, violates a variety of rights, including copyrights and trademark rights of the owners, such as authors, studios, songwriters, and photographers.

Currently, if owners of material desire to know whether anyone is infringing upon their rights, a manual or visual comparison of the contents of every suspected or unknown file must be made. Comparing a source file to thousands or hundreds of thousands of files is an extremely difficult, if not impossible, task. Indeed, a review and search of a repository of files to ascertain whether any of the files are duplicates of protected material, in whole or in part, is currently a long, laborious, expensive, and often, imprecise process. Further, there is no method of knowing whether anyone else is researching, that is, comparing, the same sets of files. Thus, these monumental efforts may be duplicated unnecessarily.

In addition to the issue of protecting content or material, in some instances, distribution of some materials requires that mandatory information be associated with the file. For example, some federal statutes require that certain types of identifying information be associated with content files that are used on wide area networks, such as the Internet. Association of the required information with a particular file can become cumbersome and impossible as the file is distributed from user to user. Indeed, the current holder of a copy of the file may not have an ability to comply with the requirements as they may not have received the file from the original owner of the file. Existing methods do not address the problem of handling this information.

In addition, in some instances, other types of information that may affect the use or distribution of the data, such as licensing or copyright information, is also desirable to include within the file. In this manner, a prospective buyer of the file can ascertain a variety of information, including whether the person offering the file for sale is authorized to do so and thereby prevents fraud or misappropriation of the rights of others. Currently no method exists that allows on-line access to pertinent information pertaining to restrictions on use or distribution of the data, or for any other purpose.

A need in the industry exists for a system or method that allows an owner of protectable material to locate unauthorized use and distribution of such material on a network, or even a stand alone computer. A further need exists for a system or method that allows users to ascertain use or distribution limitations, and to verify the rights of the distributor of such material such that potential users of the material are assured that they are purchasing or distributing authorized copies of the materials. An additional need exists for a system or method for enabling a content owner to gather statistical data and other activity to support the digital distribution of their content. The systems and methods disclosed serve to, among other things, fulfill these needs.

### BRIEF DESCRIPTION OF DRAWINGS

The accompanying drawings, which are included as part of the present specification, illustrate the presently preferred embodiments and together with the general description and the detailed description of the embodiments given below serve to explain and teach the principles of the disclosed embodiments.

FIG. 1 is a top-level flow chart illustrating an exemplary embodiment of a method for authenticating content.

FIG. 2 is a top-level flow chart illustrating an alternative embodiment of the method for authenticating content of FIG. 1.

FIG. 3 is a top-level flow chart illustrating another alternative embodiment of the method for authenticating content of FIG. 1.

FIG. 4 is a top-level diagram illustrating an exemplary embodiment of a content authentication system.

FIG. 5 is a detail drawing illustrating an embodiment of the content authentication system of FIG. 4, wherein the content authentication system comprises a content authentication platform (CAP).

FIG. 6 is an exemplary top-level diagram illustrating an embodiment of a video manager for a video management and conversion system of FIG. 5.

FIG. 7 is an exemplary top-level diagram illustrating a list of content assets that have been ingested into a content authentication platform of FIG. 5.

FIG. 8 is an exemplary detail diagram illustrating a metadata and business rules associated with one of the assets or known contents of FIG. 7.

FIG. 9 is an exemplary diagram illustrating a list of processed inquired contents from a website, in which the processed inquired contents match at least one of the ingested assets or known contents of FIG. 7.

FIG. 10 is an exemplary detail diagram illustrating one embodiment of selected information that forms a basis for the match between the processed inquired content of FIG. 9 and the ingested assets or known contents of FIG. 7.

FIG. 11 is an exemplary diagram illustrating a match queue of inquired content queued up to be processed by one or more content recognition or protection technologies or techniques for identifying content (CRTIC) data generators.

FIG. 12 is an exemplary detail diagram illustrating an embodiment of selected inquired content in the match queue of FIG. 11.

FIG. 13 is an exemplary diagram illustrating match results for the processed inquired content in the match queue from FIG. 11.

FIG. 14 is an exemplary diagram illustrating an embodiment of a management status and a current ingestion status for the content authentication platform of FIG. 5.

FIG. 15 is an exemplary diagram illustrating an embodiment of a management status and a current matching status for the content authentication platform of FIG. 5.

FIG. 16 is an exemplary diagram illustrating an alternative embodiment of the management status and a current matching status for the content authentication platform of FIG. 5.

FIG. 17 is an exemplary diagram illustrating an embodiment of an administration status for managing users accessing the content authentication platform of FIG. 5.

FIG. 18 is an illustration of an exemplary computer architecture for use with the content authentication system of FIG. 4.

It should be noted that the figures are not drawn to scale and that elements of similar structures or functions are generally represented by like reference numerals for illustrative purposes throughout the figures. It also should be noted that the figures are only intended to facilitate the description of the preferred embodiments of the present disclosure. The figures do not illustrate every aspect of the disclosed embodiments and do not limit the scope of the disclosure.

### DETAILED DESCRIPTION

A system for authenticating content and methods for making and using same.

In the following description, for purposes of explanation, specific nomenclature is set forth to provide a thorough understanding of the various concepts disclosed herein. However it will be apparent to one skilled in the art that these specific details are not required in order to practice the various concepts disclosed herein.

Some portions of the detailed description that follow are presented in terms of processes and symbolic representations of operations on data bits within a computer memory. These process descriptions and representations are the means used by those skilled in the data processing arts to most effectively convey the substance of their work to others skilled in the art. A process is here, and generally, conceived to be a self-consistent sequence of sub-processes leading to a desired result. These sub-processes are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission, or display devices.

The disclosed embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk, including floppy disks, optical disks, CD-ROMS, and magnetic-optical disks, read-only memories (“ROMs”), random access memories (“RAMs”), flash memories, erasable programmable read-only memories (EPROMs), electrically erasable programmable read-only memories (EEPROMs), magnetic or optical cards, or any other type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct more specialized apparatus to perform the required method sub-processes. The required structure for a variety of these systems will appear from the description below. In addition, the disclosed embodiments are not described with reference to any particular programming language. It will be appreciated that a variety of programming languages may be used to implement the teachings of the disclosed embodiments.

Generally, a computer file is a block of arbitrary information, or resource for storing information, which is available to a computer program and is usually based on some kind of durable storage. A file is durable in the sense that it remains available for programs to use after the current program has finished.

The disclosed systems and methods provide for an open platform approach to deploying content recognition or protection technologies or techniques for identifying content (hereinafter “CRTIC”). Examples of CRTIC can include, without limitation, digital fingerprinting of audio or video files, watermarking of video or audio files, and other unique file identifiers (which may be protocol specific). In addition to the issue of protecting content or material, in some instances, distribution of some materials requires that mandatory information be associated with the file. For example, some federal statutes require that certain types of identifying information be associated with content files that are used on wide area networks, such as the Internet. CRTIC could also refer to these certain types of identifying information.

In computing, a platform describes some sort of hardware architecture or software framework (including application frameworks), that allows software to run. The open platform approach can provide for opportunity to both accelerate the deployment of technologies and reduce technology risk, thereby providing a complete solution to content identification scenarios that content owners currently face. Further, it can provide for a foundation for building monetization models with viewership-based advertising models and targeted advertising models through the ability to identify content.

Generally, a digital watermark (or “watermark”) is a tag attached to content during the production process, which can later be used to identify the content. It can be represented as an audio, visual, and/or invisible digital mark to identify the content. Digital watermarking is the process of embedding auxiliary information into a digital signal. Depending on the context, the notion digital watermark either refers to the information that is embedded into the digital signal or to the difference between the marked signal and the digital signal. Watermarking is also closely related to steganography, the art of secret communication.

A digital watermark is called robust with respect to a class of transformations T if the embedded information can reliably be detected from the marked signal even if degraded by any transformation in T. Typical image degradations are JPEG compression, rotation, cropping, additive noise and quantization. For video content temporal modifications and MPEG compression are often added to this list. A watermark is called imperceptible if the digital signal and marked signal are indistinguishable with respect to an appropriate perceptual metric. In general it is easy to create robust watermarks or imperceptible watermarks, but the creation of robust and imperceptible watermarks has proven to be quite challenging. Robust imperceptible watermarks have been proposed as tool for the protection of digital content, for example as an embedded ‘no-copy-allowed’ flag in professional video content.

A digital watermark could also refer to a forensic watermark. A forensic watermark refers to a watermark intended to provide forensic information about the recipient of a content file designated by the content rights owner.

In computer science, a fingerprinting process is a procedure that maps an arbitrarily large data item (such as a computer file) to a much shorter bit string, its fingerprint, that uniquely identifies the original data for all practical purposes. Fingerprints are typically used to avoid the comparison and transmission of bulky data. For instance, a web browser or proxy server can efficiently check whether a remote file has been modified, by fetching only its fingerprint and comparing it with that of the previously fetched copy. To serve its intended purposes, a fingerprinting process desirably should be able to capture the identity of a file with virtual certainty. In other words, the probability of a collision—two files yielding the same fingerprint—should be negligible.

When proving the above requirement, one may take into account that files can be generated by highly non-random processes that create complicated dependencies among files. For instance, in a typical business network, one usually finds many pairs or clusters of documents that differ only by minor edits or other slight modifications. A good fingerprinting process desirably may ensure that such “natural” processes generate distinct fingerprints, with the desired level of certainty.

Computer files are often combined in various ways, such as concatenation (as in archive files) or symbolic inclusion (as with the C preprocessor's #include directive). Some fingerprinting processes allow the fingerprint of a composite file to be computed from the fingerprints of its constituent parts. This “compounding” property may be useful in some applications, such as detecting when a program needs to be recompiled.

Rabin's fingerprinting process is the prototype of the class. It is fast and easy to implement, allows compounding, and comes with a mathematically precise analysis of the probability of collision. Namely, the probability of two strings r and s yielding the same w-bit fingerprint does not exceed max(|r|,|s|)/2^{w-1}, where |r| denotes the length of r in bits. The process requires the previous choice of a w-bit internal “key,” and this guarantee holds as long as the strings r and s are chosen without knowledge of the key. Rabin's method is not secure against malicious attacks. An adversary agent can easily discover the key and use it to modify files without changing their fingerprint.

Cryptographic grade hash functions generally serve as good fingerprint functions, with the advantage that they are believed to be safe against malicious attacks. However, cryptographic hash processes such as MD5 and SHA are considerably more expensive than Rabin's fingerprints, and lack proven guarantees on the probability of collision. Some of them, notably MD5 are no longer recommended for secure fingerprinting. However they still may be useful as an error checking mechanism, where purposeful data tampering isn't a primary concern. Numerous proprietary fingerprinting processes also exist and are being developed, the utilization of any falling within the scope of the disclosed embodiments.

Digital fingerprinting also refers to a method to identify and match digital files based on digital properties, trends in the data, and/or physical properties. For example, image properties and trends can be based on color and relative positioning. For video, the properties and trends may be luminance and/or color, and pixel positioning for every certain number of frames. For audio, the properties and trends may be the change in amplitude of the sound wave over time. When tracking those properties and trends, one might end up with a fingerprint that is smaller than if the entire file was copied. The use of digital fingerprints allows one to compare and match imperfect copies of the digital files that represent the same content. One advantageous aspect of utilizing digital fingerprinting is the ability to handle a large number of verifications. The fingerprint can be applied later to other data or files to see if they represent earlier fingerprinted content. The probability of a match can be based on proprietary processes used to create digital fingerprints.

The fingerprinting operation set forth above can comprise any conventional type of fingerprinting operation, such as in the manner set forth in the co-pending U.S. patent applications, entitled “Method, Apparatus, and System for Managing, Reviewing, Comparing and Detecting Data on a Wide Area Network,” Ser. No. 09/670,242, filed on Sep. 26, 2000; and entitled “Method and Apparatus for Detecting Email Fraud,” Ser. No. 11/096,554, filed on Apr. 1, 2005, which are assigned to the assignee of the present application and the respective disclosures of which are hereby incorporated herein by reference in their entireties.

The open platform approach allows a CRTIC provider or multiple CRTIC providers (such as digital fingerprinting technology providers) to participate when their technology has demonstrated threshold level of performance or confidence. The CRTIC may perform within a level of tolerance because it can be integrated into an existing platform that deploys human based processes for content identification. So long as the CRTIC achieves a threshold level of accuracy, the platform bridges the gap with human identification processes, while achieving greater scale with the CRTIC.

For example, if a fingerprinting technology can only process 90% of the candidate set, the 10% gap can be bridged with existing human processes, while at the same time benefiting from the scale of the fingerprinting technology 90% of the candidate set. Alternatively, if a fingerprinting technology has been tuned such that the false positive probability is at an acceptable level that it is only identifying a fraction, say 60%, of actual copyright content in a pool where there is an expectation of a larger proportion of copyright material, the platform approach can provide flexibility to run identification or verification by human processes as well as other CRTIC either in parallel or in series.

The human identification or verification processes can be part of the process no matter how accurate any CRTIC becomes since identification scenarios can occur at the limits of the CRTIC where it may not be able to make a determination. The human process likewise can spot check one or more CRTIC and cover new threat scenarios that emerge over time.

Verification or identification by human processes set forth above can comprise any conventional type of verification by human processes, such as in the manner set forth in the co-pending U.S. patent application, entitled “System and Method for Confirming Digital Content,” Ser. No. 12/052,967, filed on Mar. 21, 2008, which is assigned to the assignee of the present application and the respective disclosures of which are hereby incorporated herein by reference in its entirety.

The open platform approach likewise can reduce risk related to technology providers, specifically, performance risk and financial risk. An open platform approach allows the integration of multiple CRTIC as they mature and become available. The flexibility in deployment, such as utilizing multiple CRTIC to process a body of suspect content (or “inquired content”) as discussed above, is a tactic to address performance gaps. Additionally, given the nascent nature of the fingerprinting industry, there is a risk of the financial viability of fingerprinting technology vendors. The business model for video fingerprinting vendors is ostensibly for websites, such as web media or video sites or user generated content sites, to purchase and deploy these technologies. However, unless there is continued concerted effort to convince websites to take this action, these websites likely can delay any purchase decision and force the fingerprinting technology vendors to retreat from the market in the absence of any other source of revenue. Further, under the proper circumstances, the websites may be induced to purchase the ongoing filtering service of the platform thereby creating a short term revenue opportunity for the vendors.

An additional risk addressed by the open platform approach is the availability of a solution that is transparent to all participants and where content owners have an audit trail of where their content is seen and/or removed. If reliance is placed only on tools provided by a web video site, the transparency can be much reduced as any filtering takedown action can happen using such a tool with uncertain prospects of an audit trail and evidence preservation being made available.

Further, there is also risk with using a web site's own tool, specifically with how that website (the Google websites in particular) might use the identification information. Given Google's very broad reach on the Internet and strengths in collecting, storing, and analyzing vast quantities of information, one goal with any Google tool or Google controlled identification technology could be the collection and analysis of information that can be relevant in their efforts to refine their search processes as it related to video content.

The open platform approach allows for development with participating content owners to create an approach to content search as it pertains to content referenced in the system, with identifying features (eventually a combination of CRTICs) at the point of provisioning in a manner where the owners of the content are able to promote the use of identification technologies, while retaining control of the uses of the CRTIC of their content and reduce the risk of this secondary usage.

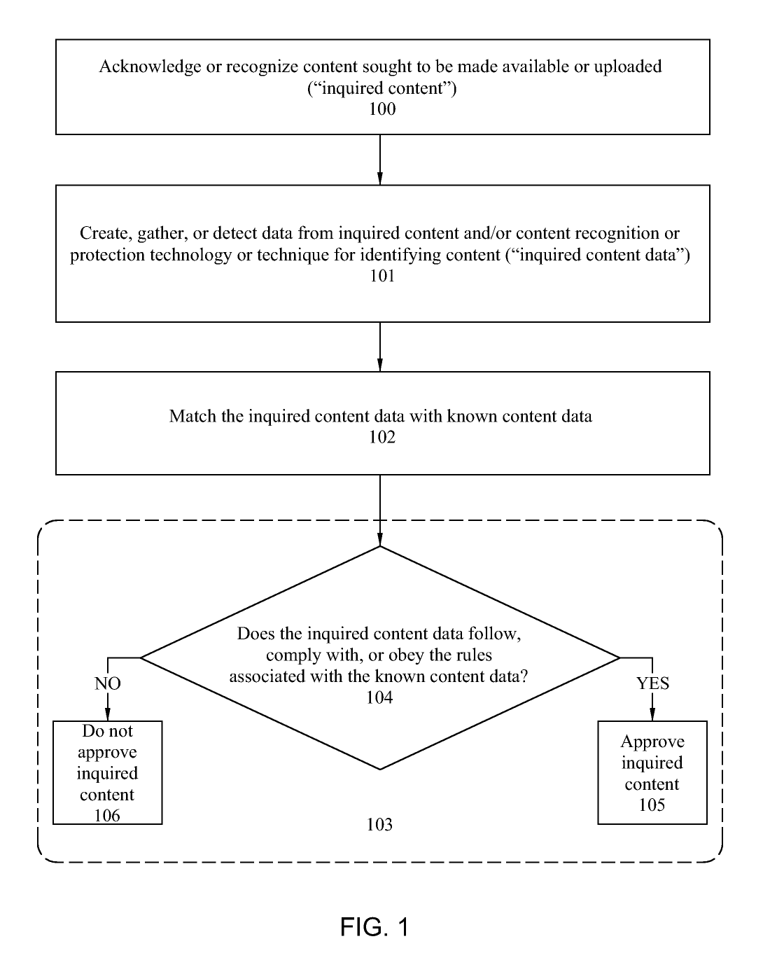

FIG. 1 is a top-level flow chart illustrating an exemplary embodiment of a method for authenticating content. As shown in FIG. 1, the method can comprise acknowledging or recognizing 100 that there is content sought to be uploaded or made available (hereinafter “inquired content”) onto a computer, server, or a network of any kind, including, without limitation, a wide area network, the Internet, internet protocols, websites, local area network, or other media distribution systems. The exemplary method is illustrated in FIG. 1 as including creating, gathering, or detecting data 101 (hereinafter “inquired content data”) from inquired content and one or more CRTIC. Any CRTIC (including proprietary CRTIC), examples of which are provided above, may be utilized. For example, if the inquired content already is associated with CRTIC, such as a watermark, the format, form, or type of inquired content data preferably is compatible with that CRTIC. Further, if no inquired content data exists, or if the inquired content data is not compatible with a desired CRTIC, the desired CRTIC's process or method may be utilized to create inquired content data that is compatible with the desired CRTIC.

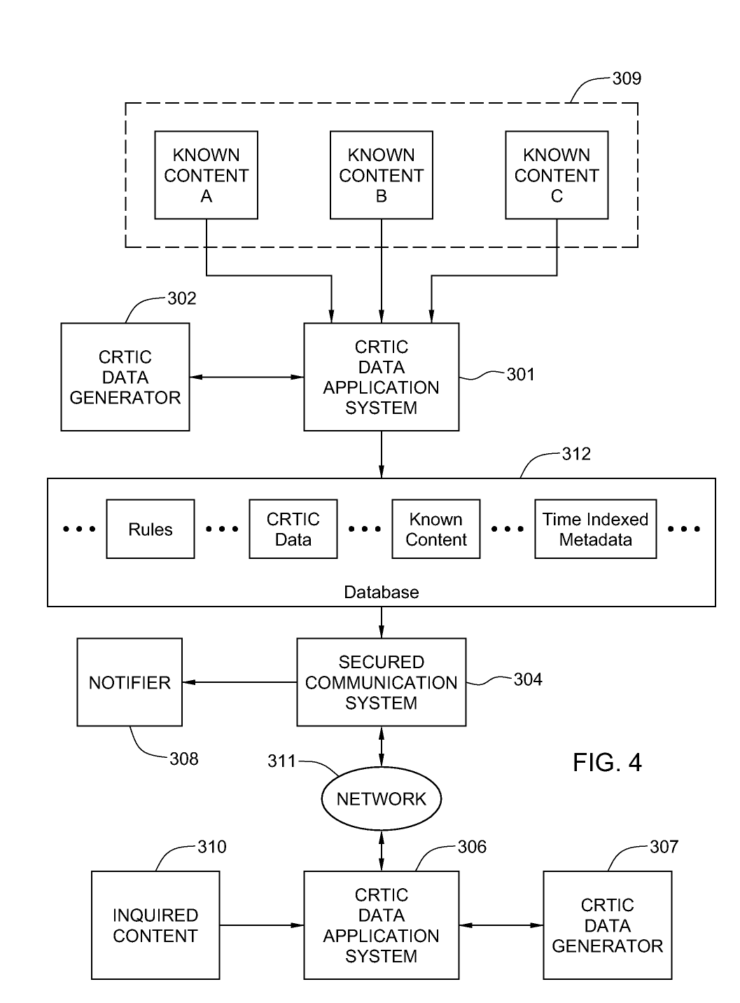

The method of FIG. 1 likewise can include, at 102, matching of inquired content data 310 (shown in FIG. 4) with known content data 309 (shown in FIG. 4). “Known content” refers to content where the owner of the content's rights is ascertainable or known. Examples of content can include, without limitation, music, videos, movies, books, photographs, articles, software, or other material. “Known content data” refers to data created utilizing one or more CRTIC. For example, the known content data for known content could be a fingerprint (compatible with a certain CRTIC, i.e. a proprietary fingerprinting technology) of the file comprising the known content.

Matching of inquired content data with known content data 102 may require that the same CRTIC process or method be utilized to create each data. If the inquired content data and the known content data are not compatible with the same CRTIC, the inquired content or the known content, or both, may need to be processed by a CRTIC to create data that is compatible with the desired CRTIC compatibility. “Matching” the two data refers to a comparison of the two data to determine that whether any match between the two data exists. Matching could comprise determining whether the inquired content data and the known content data represent the same file or portions of a file. For example, a match can be considered successful between an inquired content data and a known content data even if the inquired content data only represents two minutes of a (known content) video that is truly thirty minutes long and all thirty minutes are represented by the known content data. In an alternative embodiment, to be considered a match, the known content may total a certain amount of time or make up a certain percentage of the inquired content. In another alternative embodiment, a match is reviewed to determine whether the match was made by audio identification, video identification, both audio and video identification, or any other identification technologies.

Once inquired content data is matched with known content data, the present embodiment can determine whether the inquired content should be approved for uploading or making available 103. To do so, the present embodiment would determine whether the inquired content data follows, complies with, or obeys the rules associated with the known content data 104.

“Rules” (or “business rules”) refers to the ability to place regulations or principles that govern conduct, action, or procedure to assist the automation of almost any decision framework for the known content. The rules may be vigorous and/or numerous for each known content. The rules may be detection rules or disposition rules. The rules may provide for the monitoring or measuring of web activity related to a specific known content. For example, a rule or rules associated with known content can establish how the known content can be used, monitor the known content, and allocate advertising revenue based on distribution agreements with a hosting website. In another example, a rule may exclude the first or last portions or seconds of video to avoid detection or matching on standard visual items like logos or credits. A rule or set of rules may also be associated with the known content data. The association of a rule or set of rules with known content can be also associated with the known content data for that known content. The rules may be altered, reconfigured, customized or changed at any time (usually at the request of the known content's rights owner).

For example, if a rule requires that a known content not ever be approved for uploading or making available, the inquired content, at 106, will not be approved. If the rule in the example required that only a certain segment or portion of known content be approved for uploading or making available, the inquired content, at 105, will be approved if there was a successful match 102 and the inquired content only comprised that certain segment or portion. In other words, since the inquired content data and the known content data were a successful match, the inquired content data (which represents the inquired content) followed, complied with, or obeyed the rule associated with the known content (or the rule associated with the known content data), the present embodiment authorized or approved the uploading or making available of the inquired content. Another example of a rule may be that if an unidentified or unidentifiable portion of inquired content exists, the inquired content should be further reviewed. Utilizing inquired content data and known content data to conduct the matching is an advantageous aspect of one or more embodiments disclosed.

One embodiment of a rule or business rule can utilize Time Indexed Metadata (hereinafter “TIM”). TIM can be utilized to implement even more granular rules based on where the inquired content appears in reference to the known content. For example, one could selectively choose when to set a rule for a known content or known content data. The selection may be made based on times in the known content where advertising or other monetization opportunities exist.

For example, TIM can be created or derived by processing the properties of a known content, either by human, apparatus, or computer based techniques. The processing of the known content creates or derives tags or other descriptive data based on the time code of the content. For example, in a ninety minute video of a featured film (the known content), the opening credits may begin thirty five seconds from the beginning of the video and end at eighty seconds from the beginning. This forty five second segment of opening credits can be tagged as such. This information (or TIM) can be utilized to construct rules that are designed specifically to this segment, such as to put less weight to matches found between inquired content and known content based off of this segment.

Another example of a rule based of the utilization of TIM is a segment in a ninety minute video where the segment comprises matter that specialized advertising could be applied to. For example, the segment could comprise TIM that a certain muscle car appears within it. If a match is found between the inquired content and the known content, where the inquired content also comprises the segment, the descriptive data (or TIM) could help create a rule that allows for special advertising time for the maker of the muscle car. The rule based off the TIM would help create specialized advertising techniques, which may allow for higher advertising fees for the advertiser. An advantageous aspect of the disclosed embodiments is the ability to create specialized advertising techniques by utilizing the knowledge gained over the usage of known content.

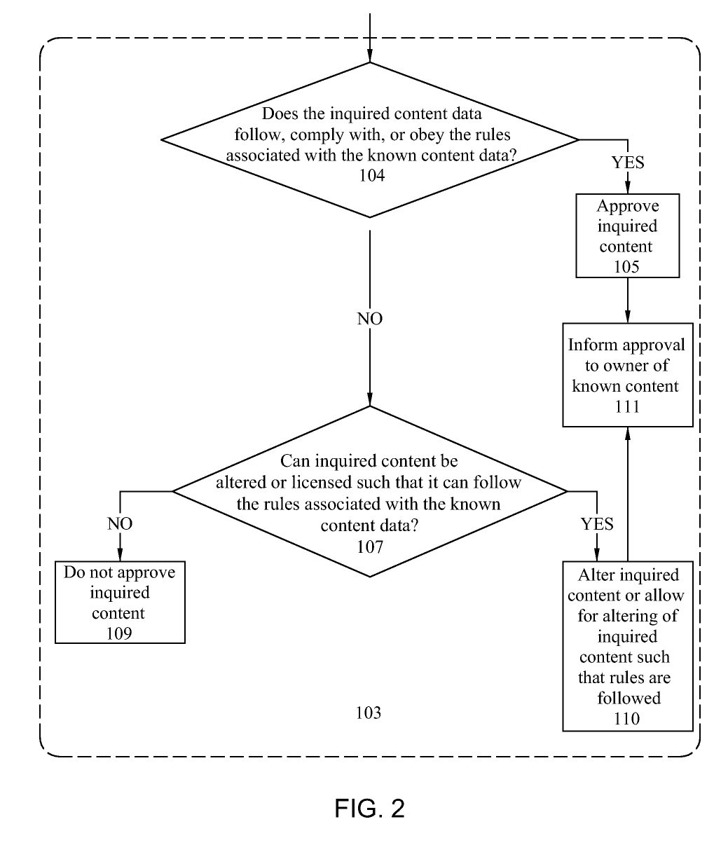

FIG. 2 is a top-level flow chart illustrating another exemplary embodiment of a method for authenticating content. FIG. 2 is provided to illustrate an alternative embodiment for determining whether the inquired content should be approved for uploading or making available 103 from the embodiment in FIG. 1. As shown in FIG. 2, the method can comprise determining whether the inquired content data follows, complies with, or obeys the rules associated with the known content data 104 as explained above. If the determination is that the inquired content data does not follow, comply with, or obey the rules, the present embodiment would comprise the determination of whether the inquired content can be altered or otherwise licensed such that it can follow, comply with, or obey the rules associated with the known content data 107. If the determination 107 is that the inquired content cannot be altered accordingly, the exemplary method would not approve the inquired content 109. If the determination 107 is that the inquired content can be altered accordingly, the exemplary method would alter the inquired content or allow for the altering of the inquired content and approve of the inquired content 11 0. In another embodiment, the determination 107 can effectuate a suggested alteration of the inquired content such that the inquired data would fulfill the relevant rule or rules. Once altered, the inquired content may need to be re-verified by the embodiments described to determine whether the altered inquired content is approved for uploading or making available.

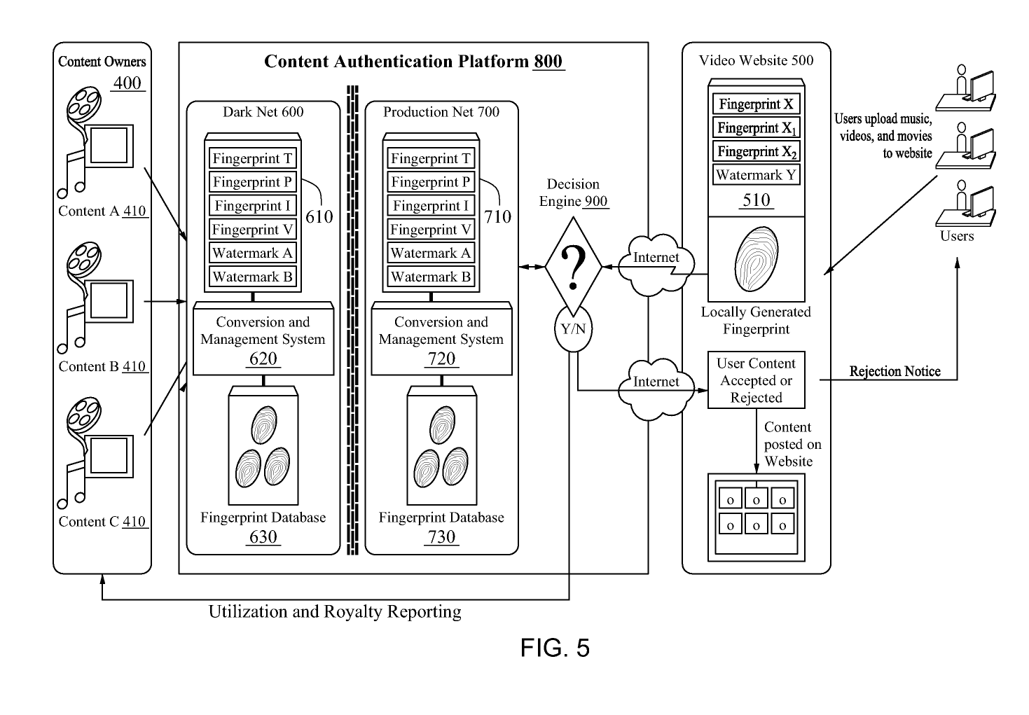

In another alternative embodiment, the owner of the known content is informed 111 whether an inquired content or an altered inquired content has been approved or not. This may be done utilizing Notifier 308 from FIG. 4, or the “Utilization and Royalty Reporting” of FIG. 5. The information sent to the owner of the known content 111 may also comprise descriptive data or metadata of the inquired content or altered inquired content. For example, the information may comprise, without limitation, the inquired content length, date and time of approval, information about the user requesting approval, quality information, and where the inquired content is uploaded or made available. Other information that may be sent can include the length of time the inquired content or altered inquired content is made available or information for the type or number of advertisements that are being associated with the inquired content or the number of times the inquired content is or has been viewed.

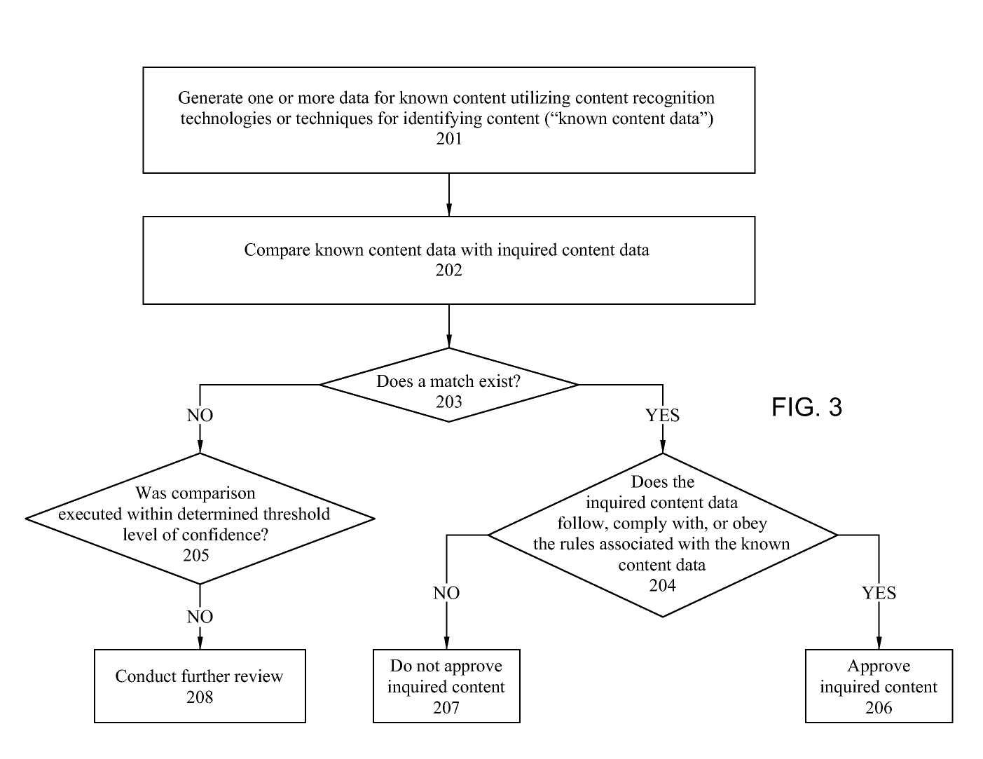

FIG. 3 is a top-level flow chart illustrating an alternative exemplary embodiment of a method for authenticating content. As shown in FIG. 3, the method can comprise the creation or generation 201 of one or more known content data based on known content processed by one or more CRTIC. The embodiment further comprises a comparison of the one or more known content data with inquired content data 202. The comparison in 202 is to determine whether a match exists between any of the known content data and the inquired content data (as explained above). If the inquired content data is not compatible with any of the one or more known content data (i.e. they aren't compatible to the same CRTIC), a compatible data could be created for the inquired content and/or the known content such that they can be compared. Once one or more known content data is compared to the inquired content data, the exemplary method can determine whether a match exists or was found 203.

If a match is not found or does not exist, the exemplary method may continue to compare inquired content data with other known content data. In an alternative embodiment, a determination would be made as to whether the comparison was executed within a determined threshold level of confidence 205. For example, there may not be enough confidence in a fingerprinting technology that was utilized in the creation of the known content data or inquired content data. For another example, the amount of inquired content may have been too small to reach the threshold level of confidence or to return a result. In one embodiment, the rules for the known content or known content data determine the threshold level of confidence.

If the comparison is not executed with the determined threshold level of confidence, the present embodiment would conduct further review of the inquired content 208 to determine whether it should be approved or not. An example of further review could be the utilization of human processes for verifying the inquired content.

As illustrated in FIG. 3, if a match is found to exist 203, the exemplary method would determine whether the inquired content follows, complies with, or obeys the rules associated with the known content data or the known content 204, as explained above. As explained above, if the rules are followed, complied with, or obeyed, the inquired content would be approved 206 along with other actions that may be specified in the rules. Accordingly, if the rules are not followed, complied with, or obeyed, the inquired content would not be approved 207. In an alternative embodiment, the rule or set of rules that were not followed, complied with, or obeyed would be conveyed to the user attempting to upload the inquired content or make it available. In an additional alternative embodiment, the exemplary method would also comprise the determination of whether the inquired content can be altered or otherwise licensed such that it can follow, comply with, or obey the rules associated with the known content data (107 from FIG. 2). Once determined, the additional sub-processes as described in FIG. 2 may also occur.

FIG. 4 is a top-level diagram illustrating an exemplary embodiment of a system for authenticating content. As illustrated in the exemplary system diagram in FIG. 4, one or more known contents 309 (shown as 410 in FIG. 5) are processed by a CRTIC Data Application System (hereinafter “CDAS”) 301. CDAS 301 and CDAS 306 may be, without limitation, an apparatus able to do the required capabilities, a processor, a general purpose computer, one or more computers, a server, or a client. The CDAS 301 is associated with, coupled to, or in communication with a CRTIC Data Generator 302. As desired, the CRTIC Data Generator 302 can be separate from, or at least partially integrated with, CDAS 301. The CRTIC Data Generator 302 creates, gathers, or derives known content data (or “CRTIC data”) as defined above and by the disclosed embodiments.

The CDAS 301 is also associated with, coupled to, or in communication with one or more database systems 312. As desired, the one or more database systems 312 can be separate from, or at least partially integrated with, CDAS 301. The one or more database systems 312 may include information (or data) utilized by the embodiment. Examples of information can include, without limitation, known content files, CRTIC data relating to the known content files, rules associated with known content files, Time Indexed Metadata, or CRTIC data (or “known content data”), statistics and/or other information of the sort. The database system 312 may incorporate the ProductionNet System 700 (as seen in FIG. 5).

Database system 312 may be accessible by the Secured Communication System 304. The Secured Communication System 304 may be, without limitation, an apparatus able to do the required capabilities, a processor, a general purpose computer, one or more computers, a server, or a client. The Secured Communication System 304 may also incorporate Decision Engine 900 (as shown in FIG. 5). An advantageous aspect of the present embodiment is the ability to access CRTIC data and/or rules and/or other metadata without providing the ability to access the known content file. Another advantageous aspect of some disclosed embodiments is the ability to prevent access to the data stored in the database system 312 such as not allowing access to the CRTIC data and/or associated metadata to CRTIC providers. Access by Secured Communication System 304 to certain data within database system 312 may also be limited.

As desired, the Secured Communication System 304 can be separate from, or at least partially integrated with, CDAS 301. As desired, the Secured Communication System 304 may be associated with, connected with, coupled to, or in communication with CDAS 301. Secured Communication System 304 is associated with, coupled to, or in communication with network 311. Network 311 refers to any sort of network, as defined above.

CDAS 306 is also associated with, coupled to, or in communication with Network 311. As illustrated in the exemplary system diagram disclosed, Inquired Content 310 is processed by CDAS 306. CDAS 306 is associated with, coupled to, or in communication with a CRTIC Data Generator 307. As desired, the CRTIC Data Generator 307 can be separate from, or at least partially integrated with, CDAS 306. CRTIC Data Generator 307 and CRTIC Data Generator 302 may each create, gather or derive compatible data. CRTIC Data Generators 307 and 302 may be the same CRTIC Data Generator or the same combinations of different CRTIC. The CRTIC Data Generator 307 creates, gathers or derives CRTIC data (or “inquired content data”) for the Inquired Content 310. The inquired content data is transmitted by CDAS 306 via Network 311 to the Secured Communication System 304. One advantageous aspect of the exemplary system illustrated in FIG. 4 is the ability to efficiently utilize different or additional CRTIC Data Generators as desired. For example, if CRTIC Data Generators 307 and/or 302 do not create data that is compatible or of the sort desired, different or additional CRTIC Data Generators could incorporated to fulfill the respective need.

The CRTIC data stored in one or more database systems 312 is compared to the inquired content data by the Secured Communication System 304. If a match is found with the CRTIC data (known content data) and inquired content data, rules associated with the CRTIC data are processed. Further, the owner or rights holder of the known content associated with the matched CRTIC data are notified by Secured Communication System 304 via a Notifier 308. The owners or rights holders may also be notified of any other sort of activity that is relevant to their content. The notification may be sent to the CDAS 301 for delivery to or receiving by the owner or rights holder. Secured Communication System 304 may be associated with, coupled to, or in communication with Notifier 308. As desired, Notifier 308 can be separate from, or at least partially integrated with, Secured Communication System 304. Secured Communication System 304 may convey to CDAS 306 the status or result of finding a matching known content data with the inquired content data via Network 311. The Notifier 308 may be utilized for “Utilization and Royalty Reporting” (as seen in FIG. 5).

The Content Authentication Platform (CAP) is a platform that is open to different media content recognition or protection technologies (or “CRTIC”) or combination of one or more CRTIC. Apart from aggregating recognition technologies, the CAP can provide a single point of reference to owners of content (or “known content”) to manage their content recognition needs in a centralized, consistent manner across multiple domains.

The benefits of aggregation of different CRTIC in this manner can include one or more of the following: combined operation of technologies increases overall accuracy and effectiveness; human intelligence integrated into the workflow process to further improve accuracy and confidence; and/or flexibility in deployment options.

The ability to combine different CRTIC together in a platform increases accuracy in detections. A combined approach is beneficial because each developer of CRTIC uses different technology approaches and there is a need to utilize the different CRTIC approaches to improve the accuracy of identifications. For example, a combination of different CRTIC can detect whether the original audio is included with the corresponding video for a given content. An advantageous aspect of some disclosed embodiments is the ability to incorporate additional CRTIC at later times. For example, the CAP may be able to incorporate a CRTIC not already incorporated. To do so, it may process all known content already incorporated with the additional CRTIC.

The overall architecture of one exemplary embodiment of the content authentication platform (CAP) 800 is shown in FIG. 5. As illustrated in FIG. 5, the CAP can include a DarkNet system 600 and/or a ProductionNet system 700. One or more content owners 400 each can provide original versions of their content 410 to be detected in the CAP 800 for processing. The content 410 can be provided in any conventional format, such as a standard digital format, for processing. As desired, content owners 400 can publish their content 410 with CRTIC such as digital marks, such as watermarks and/or fingerprints, embedded in various streams (including audio and/or video streams). Databases of the marks with identifying information can include the specific identity of the content 410, where a particular copy of the content 410 was published, as well the relevant transaction that originally occurred with the content 41 0.

The DarkNet System 600 is where original content in digital form is stored by CAP 800 for participating content partners for processing into CRTIC such as fingerprinting, watermarking, and/or other content identification technologies that build references from original source material 410. The DarkNet System 600 preferably is not accessible externally (or is subject to restricted access) by any network, and data is transferred physically on appropriate media. The DarkNet System 600 can be architected in this manner to provide maximum security for the original content so unauthorized access can only be achieve through a physical contact of the machines in the DarkNet System 600.

In one alternative embodiment, CAP 800 can provide for a secure, offline environment for content owners 400 to manage all of their content 410 they want used in the available CRTIC. This approach prevents the release of multiple copies of content and CRTIC data to any number of different vendors. Content owners 400 have full transparency and maximum control over the use of their CRTIC data while still enabling the operational deployment of the CRTIC data. Web media sites 500 benefit by allowing the creation of trusted and auditable metrics that enable development of activity based business models.

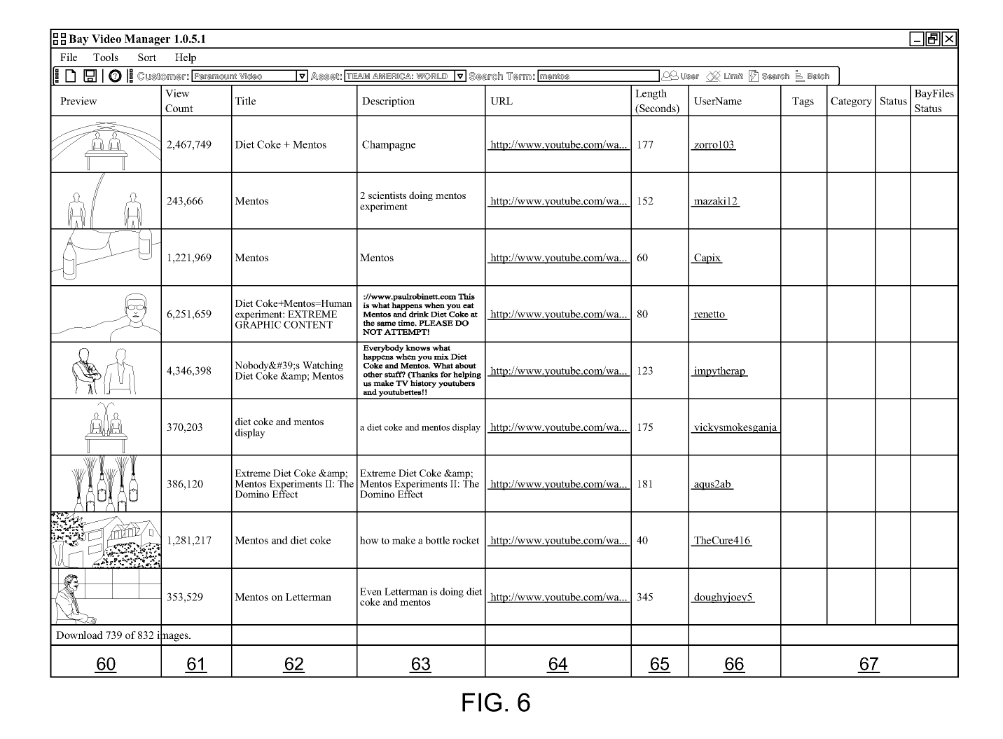

FIG. 6 is an exemplary top-level diagram illustrating an embodiment of a video manager for a video management and conversion system of FIG. 5. The column in object 60 comprises previews of inquired contents found that may match known content. The column in object 61 comprises the relevant view counts for each of the respective inquired contents found. The column in object 62 comprises the relevant titles for each of the respective inquired contents found. The column in object 63 comprises the relevant descriptive data found with each of the respective inquired contents found. The column in object 64 comprises the relevant Uniform Resource Locator (URL) that each of the respective inquired contents was found. The column in object 65 comprises the relevant length for each of the respective inquired contents found. The column in object 66 comprises the relevant username associated with each of the respective inquired contents found. The columns in object 67 comprise other descriptive data that could be associated with each of the respective inquired contents found.

In the DarkNet System 600 as illustrated in FIG. 5, the original content 410 is directed at CRTIC (i.e. fingerprinting technologies) 610 that have been integrated into the platform. This process of ingestion generates a database of CRTIC data (i.e. fingerprints) 630 for each of the respective CRTIC (i.e. fingerprinting technologies) 610 and can be used by the CRTIC (i.e. fingerprinting technologies) 610 to determine whether the CRTIC data (i.e. fingerprint) of a candidate piece (or “inquired content data”) of content of unknown identity can be matched to a CRTIC data (i.e. fingerprint) of a known asset (or “known content data”) in the CRTIC data (i.e. fingerprint) database system 630. The one or more CRTIC data (i.e. fingerprints) 630 associated with the original content 410 can be generated at any suitable time. For example, one or more fingerprints 630 can be generated for the original content 410 upon ingestion into the DarkNet System 600. The one or more CRTIC data (i.e. fingerprints) 630 likewise can be updated in any conventional manner, including periodically and/or as CRTIC (i.e. fingerprinting technology) 610 is updated to, if so desired, include, for example, new and/or improved CRTIC (i.e. fingerprinting technology). One advantageous aspect of the disclosed embodiments is the ability to incorporate additional or different CRTIC efficiently. For example, if an owner of known content desired CRTIC data for their known content from a CRTIC not already incorporated into CAP, that CRTIC could be incorporated and applied to the stored known content.

This process is managed by the Conversion and Management System (CMS) 620. The one or more CRTIC data (i.e. fingerprints) generated typically can only be used by the same technology that generated them to help identify unknown pieces of content in an expeditious manner and cannot be used to reconstitute the original source material. In the event of the development of a standardized, technology agnostic manner of creating, storing and expressing CRTIC data (i.e. fingerprints and other identifying marks) is developed, this can be easily incorporated and can simplify the operation of the system by reducing the number of databases to be created and managed.

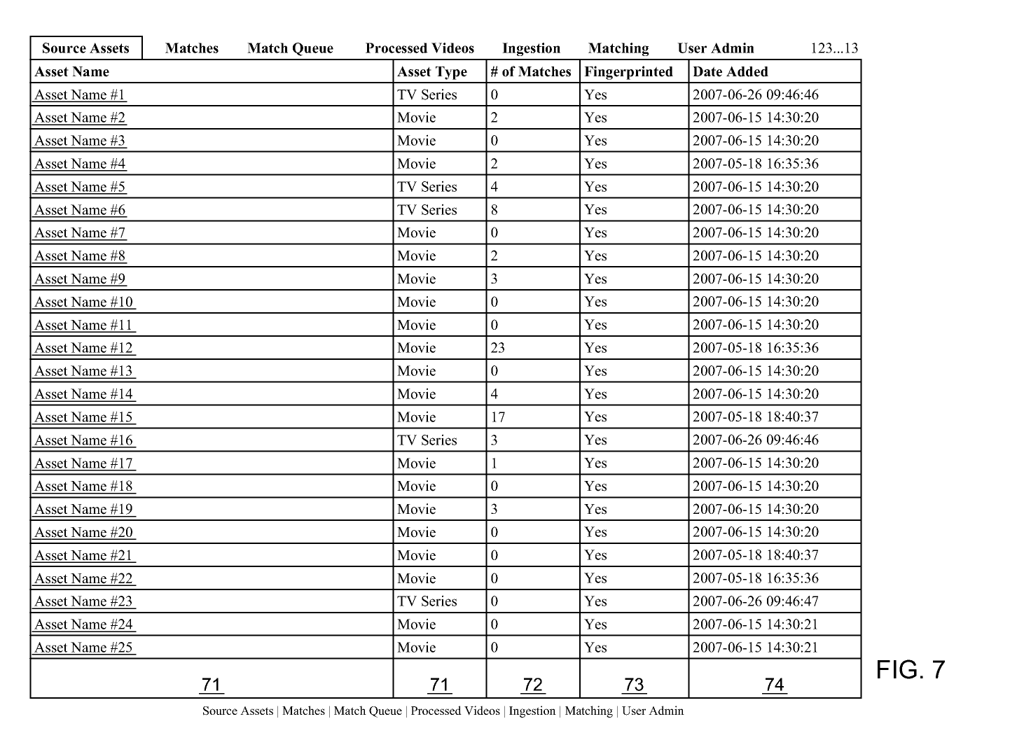

FIG. 7 is an exemplary top-level diagram illustrating a list of content assets that have been ingested into a content authentication platform of FIG. 5. The column in object 70 comprises the names of the assets or known contents. The column in object 71 comprises the relevant type for each of the respective assets or known contents from the column in object 70. The column in object 72 comprises the relevant number of matches found for each of the respective assets or known contents from the column in object 70. The column in object 73 states whether each of the respective assets or known contents from the column in object 70 has been processed by one or more CRTIC (i.e. fingerprinted). The column in object 74 states when each of the respective assets or known contents from the column in object 70 has been ingested.

As desired, the DarkNet System 600 can associate descriptive information, such as metadata, with the original content 410. The descriptive information can be generated in any conventional manner, such as from Internet Movie Database (IMDB) or information provided by the content owners 400 with the original content 410. In one embodiment, the descriptive information can include one or more user-defined entries, such as entries defined by the CAP 800. Preferably, the descriptive information is not included with the original content 410 provided to the CRTIC (i.e. fingerprinting technology) 610. If the CAP 800 assigns an internal identification number to the original content 410, the identification number can be included with the descriptive information for the original content 410 and provided to the CRTIC (i.e. fingerprinting technology) 610 to facilitate continuity in processing the original content 41 0.

The CRTIC data (i.e. fingerprints) can be transferred to the ProductionNet system 700 for use in matching candidate files (or “inquired content”) that are brought into the CAP 800. In an alternative embodiment, the ProductionNet system can receive any or all data or information mentioned below and illustrated in FIG. 5 from another source, such as directly from the owner of known content. Preferably, the one or more CRTIC data (i.e. fingerprints) are transferred to the ProductionNet system 700 through a highly-secure manner, such as a physical transfer. The ProductionNet system 700 is part of a secure network that interfaces directly with integrated media sites with media of interest or through results returned by versions of conventional crawler technology, including the Web Media Indexing Tool. The ProductionNet system 700 likewise comprises databases of watermarks of watermarked media using technology integrated in the CAP 800 and used by CAP content partners to generate identifying marks. The Content Management System (FMS) 720 sends CRTIC data, such as fingerprints of and/or watermarks, detected in candidate media files to the CRTIC data (i.e. fingerprint and/or watermark) database system 730 of the corresponding technology 710 for matching. The CRTIC data (i.e. fingerprints and/or watermarks) are stored with only a unique reference identifier, such as an asset identifier, which is known to the FMS 720. The asset identifier key forms part of the FMS 720 accessible only through the CAP 800 and not directly stored in conventional content recognition technology database systems. An efficient manual review process with integrated workflow management and reporting tools is architected into the platform for use as necessary. The asset identifier can be applied as a mechanism to link content recognition database systems with the actual identity of an asset and associated metadata and business rules (or “rules” as defined above). The business rules can include, without limitation, criteria such as a threshold time duration for permitted use of the content, licensing terms for use of the content, a list of licensees of the content, permitted (and/or impermissible) uses of the content, and/or selected content that may be used without restriction. As desired, the business rules may be static and/or dynamic over time. The FMS 720 can provide a link between a fingerprint or watermark or other CRTIC data to the metadata that describes the asset (or “known content”) and associated business rules for that asset.

The business rules that apply to an asset identified in the CAP 800 are maintained and consistently applied by a Decision Engine system 900. The decision engine system 900 is a centralized repository of business rules, or is associated with a centralized repository of business rules, specified by content owners to reflect the prevailing business arrangements around content that has been identified on media websites. The decision engine system 900 allows granular level control at an asset level that can take predetermined action based on where a content owner's asset was found, when it was found, the quantities in which it was found and can continue to collect information on these assets as part of an ongoing response. The decision engine system 900 may also send information to users or websites that host inquired content.

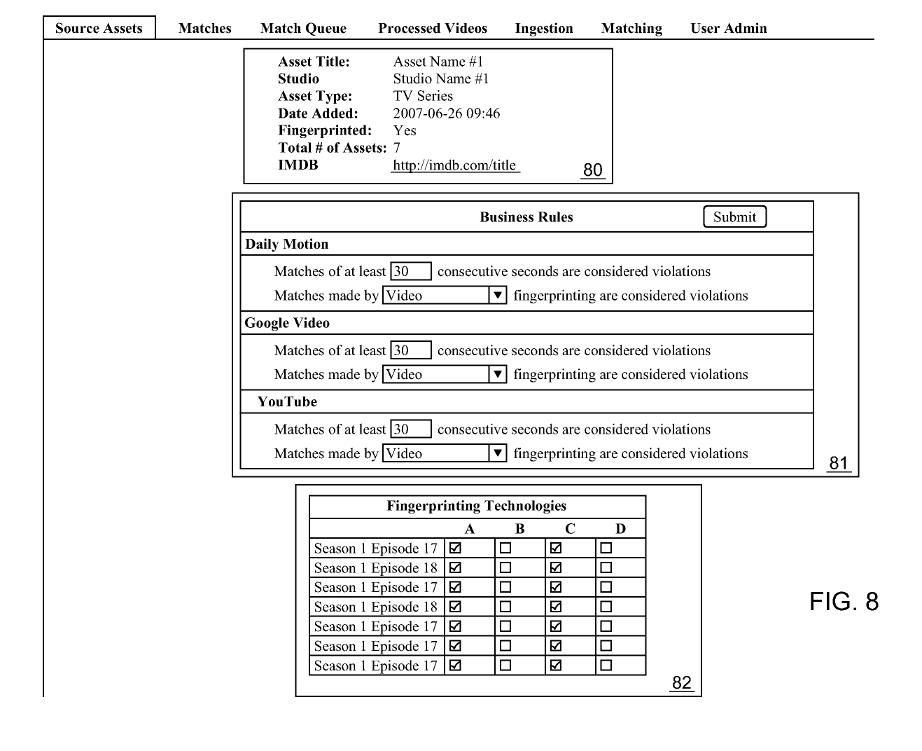

FIG. 8 is an exemplary detail diagram illustrating a metadata and business rules associated with one of the assets or known contents of FIG. 7. The information represented in object 80 comprises examples of metadata for one of the assets or known contents. The information represented in object 81 comprises one or more business rules associated with the respective asset or known content from object 80. The information represented in object 82 comprises examples of more metadata associated with the respective asset or known content from object 80. Object 82, for example, comprises different episodes of the a television show series and displays which CRTIC was applied to which episode.

One initial application of the decision engine system 900 is to remove infringing content on unauthorized websites among other places on the internet as this addresses an immediate issue content owners are experiencing. The workflow can be configured to use multiple identification technologies (CRTIC) that have been integrated including video, audio and combinations of these techniques. Preferably, there is real time monitoring of data flow. As desired, applications of the decision engine system 900 can include using the unique arrangement of these technologies to enable new distribution models and underpin the monetization of content on authorized channels including the tracking of views for advertising-based business models, serving targeted advertising in and/or specific content streams at specific websites at specified times.

By getting a more complete understanding about how their content is used on web media sites, such as user generated content sites (an example being the YouTube site), the platform can provide content holders with the ability to measure both the authorized and unauthorized use of their content on the web media sites. With this information, revenue sharing agreements can be made with the web media sites. At that point, the platform could serve the role of making sure that the terms of the agreement are complied with or obeyed, and can provide a measure (using both automated technology and human resources) of what actually occurs on the sites so the advertising revenue is properly distributed to the proper party.

One example of an advertising revenue model could be based upon information provided to video or media website 500. For example, the information provided could include what percentage of the inquired content is known content. In an additional example, the information provided could include what percentage of inquired content is a one known content and what percentage of the inquired content is another known content. In an alternative example, the information provided could include what percentage of the inquired content should be approved. The information provided to the video or media website 500 may be utilized to determine the amount of advertising revenue to allocate for the content owner of known content.

The ability to track activity to a specific piece of content can provide a basis to developing reliable metrics or advertising based distribution models. Users may be authorized to create and upload clips of copyrighted material onto web media sites. The platform can identify these new appearances of copyrighted material, and according to the distribution agreements in place, can advise and help content owners (via “Utilization and Royalty Reporting”) collect advertising or other revenue created by this identification.

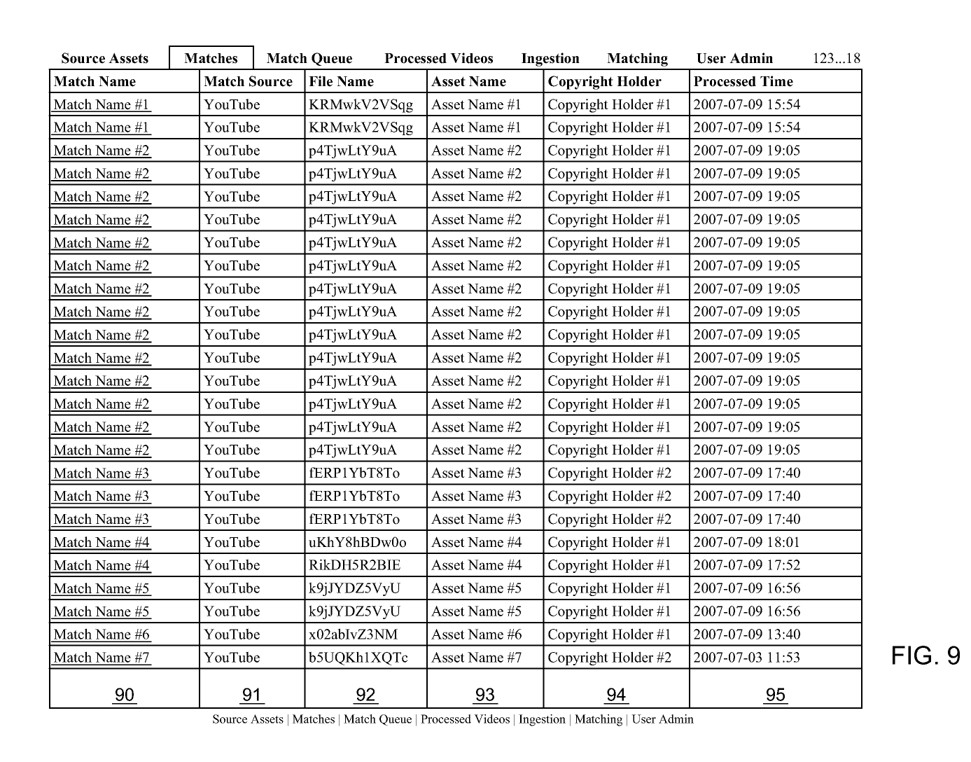

FIG. 9 is an exemplary diagram illustrating a list of processed inquired contents from a website, in which the processed inquired contents match at least one of the ingested assets or known contents of FIG. 7. The column in object 90 comprises the names of the inquired contents found that match ingested asset or known content. The column in object 91 comprises the source name of the location (i.e. website) for each of the respective inquired contents found. The column in object 92 comprises the file name of each of the respective inquired contents found. The column in object 93 comprises the name of the asset or known content that match each of the respective inquired contents listed in the column in object 90. The column in object 94 comprises the names of the copyright holders for each of the respective assets or known contents listed in the column in object 93. The column in object 95 comprises the time and date each of the respective matches were processed.

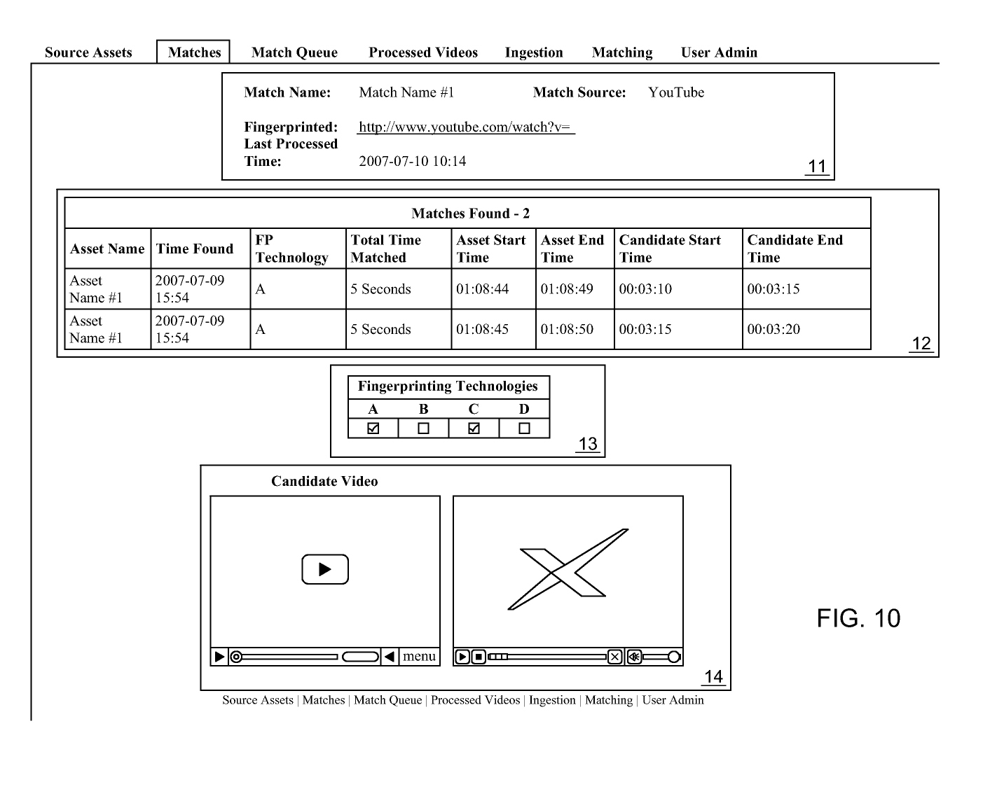

FIG. 10 is an exemplary detail diagram illustrating one embodiment of selected information that forms a basis for the match between the processed inquired content of FIG. 9 and the ingested assets or known contents of FIG. 7. The information represented in object 11 illustrates detailed information regarding the inquired content, including the name, the web address the inquired content was located, and when the inquired content was processed. The information represented in object 12 illustrates detailed information in regards to the portion of the assets or known contents that the match was located to. For example, the information comprises the asset names, the time the matches were found, the total time matched for each asset, the start time of the portion of the respective asset matched, the end time of the portion of the respective asset matched, the start time of the matched portion in the inquired content, and the end time of the matched portion in the inquired content. The information represented in object 13 illustrates the one or more CRTIC utilized to process the match. For example, the information comprises the different types of fingerprinting technologies that where selected for the matching. The information represented in object 14 can provide for the viewing of the inquired content and the asset or known content.

The identification process may also provide a feed to websites of time-coded metadata (which is maintained in the platform) specific to the clip that can increase the ability to serve even more relevant advertising to users. One example of time-coded metadata may be TIM. The platform, using this identification capability, can also allow content owners to specify advertising campaigns that may appear with content at defined periods of time. The platform can provide content owners with the ability to allow users to interact with their content, which in turns allows for a systematic approach to finding out where this content is appearing while at the same time generating new revenue streams from this new audience.

In one preferred embodiment, the CAP 800 can communicate with one or more video/media websites 500 (or nonparticipating sites) as illustrated in FIG. 5. As desired, the CAP 800 likewise can include one or more CRTIC data generators (i.e. fingerprint generators) 510 to extract fingerprints from candidate files (“inquired content” file), watermark detectors to extract watermarks, and/or any other content identification technology (CRTIC) that may be integrated to process media files. The CRTIC data generators (i.e. fingerprint generators) 510 can be applied to a selected candidate file at any suitable time, such as while the candidate file is being uploaded to the website 500, before the candidate file is posted on the website 500, and/or after the candidate file is posted on the website 500. The capacity of the content recognition or protection technology (CRTIC) deployed can depend upon the expected level of activity on the website 500 into which the CAP 800 is being integrated. For example, the content recognition or protection technology (CRTIC) can be deployed separately from CAP 800, integrating into the workflow of the website, and/or it can be encapsulated partially and/or wholly into CAP 800. In either case, the implementation is integrated into the workflow and index of the website 500.

One integration point is in the process of the website 500 where users upload content. For example, an application programming interface (API) could be provided for website operators. However, data can be integrated from multiple online sources in a wholly integrated manner or using other entry points. The upload process for a specific file is suspended until a result and possible intervening action is triggered by the decision engine system 900. When media is uploaded onto a website 500, CRTIC data (i.e. a fingerprint) is generated locally and CRTIC detectors (i.e. watermark detectors) seek appropriate marks. Fingerprints, any detected marks, or any other CRTIC data, can be encapsulated in their own conventional wrappers and associated with a generated unique transaction identifier (UTI) that can include, among other things, the site that generated the transaction request, the time this request was generated and other descriptive and diagnostic data.

This payload is transmitted over a secure link to the decision engine system 900 that sends one or more CRTIC data, such as fingerprints and any included watermarks, to their respective conventional database systems in the FMS 720. The results for a match can return with the UTI with the matched asset identifier and can include a clear violation, no violation, and/or an indeterminate (or intermediate) result. Where the content recognition technologies are unable to definitively make a clear, unambiguous determination, these recognition cases can be provided to a human identification process using workflow management tools. This human identification process likewise can be used to help tune recognition technologies and to ensure these technologies are operating within expected parameters.

This is passed to the decision engine system 900 to look up the business rules using the UTI for the matched. The decision engine system 900 can apply the business rules to the upload content at any suitable time, such as before and/or after the upload content is posted on the website 500. The actions prescribed in the business rules are returned to the website 500 through the associated UTI and the secure data link to inform the website workflow management system of the action to take with the identified media. In the situation where there is no match returned associated with a particular UTI, this result is passed directly back to the website 500 through the decision engine system 900 and secure data link to release the transaction to the next process in the website's workflow. In a filtering context, the action would be to reject a particular upload to a particular site if the upload contained media that has been identified as the property of a participating content owner and where there has been no authorization to allow content on the website being filtered.

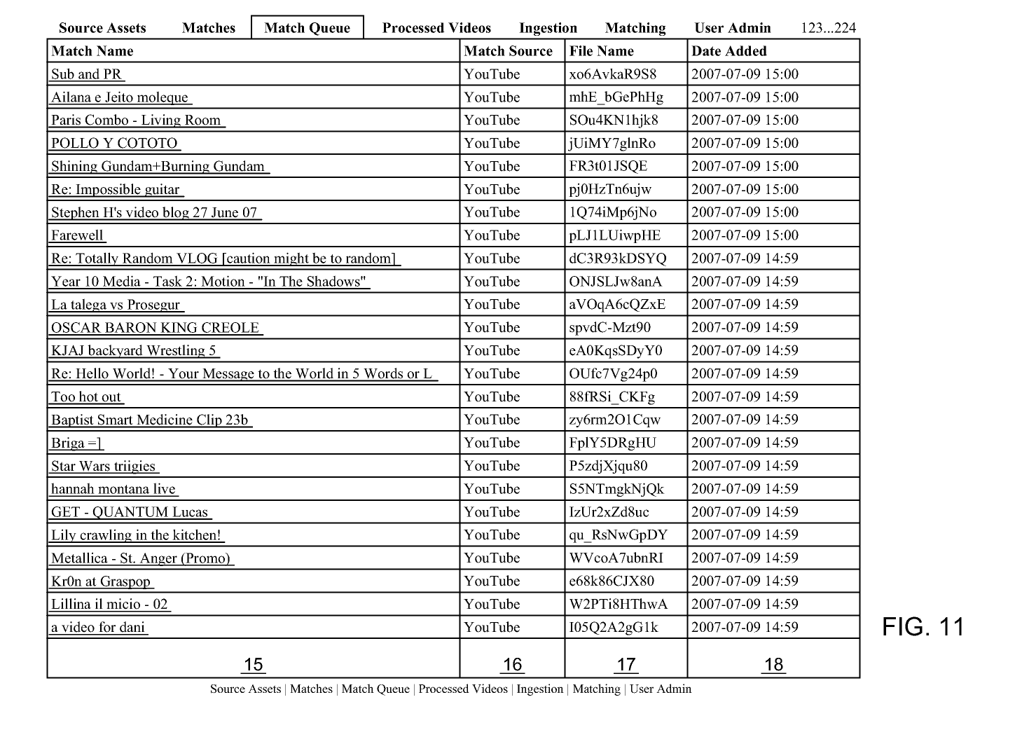

FIG. 11 is an exemplary diagram illustrating a match queue of inquired content queued up to be processed by one or more CRTIC data generators 510. The column in object 15 lists the names of the inquired content queued up for processing by one or more CRTIC data generators 510. The column in object 16 lists the source or location of each of the respective inquired contents from object 15. The column in object 17 lists the file names for each of the respective inquired contents from object 15. The column in object 18 lists the dates and times each of the respective inquired contents from object 15 where added to the queue.

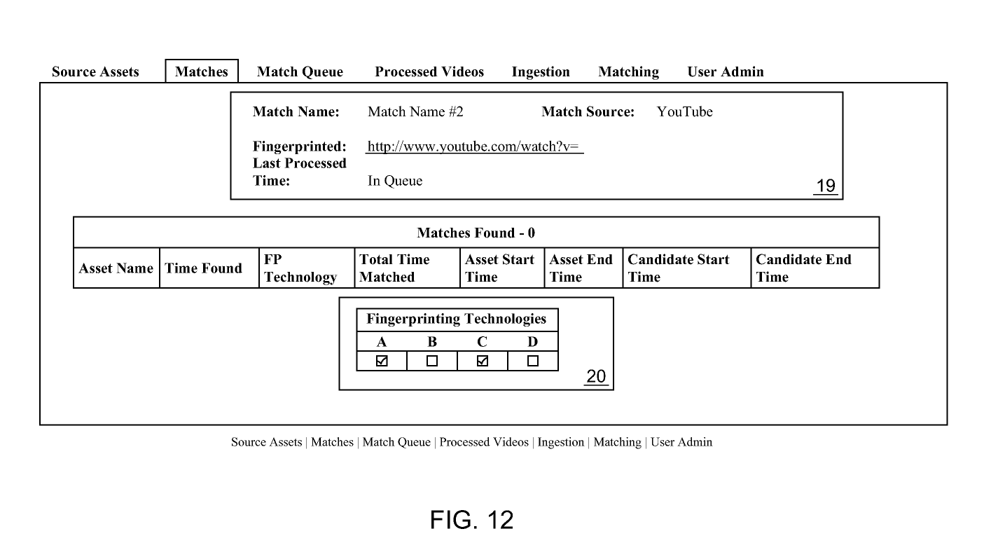

FIG. 12 is an exemplary detail diagram illustrating an embodiment of selected inquired content in the match queue of FIG. 11. The information represented in object 19 illustrates the descriptive data of the inquired content, such as the name (“Match Name”), location it was found (“Match URL”), and when it was processed by one or more CRTIC (“Last Processed Time”). The information represented in object 20 illustrates the one or more CRTIC selected to process the inquired content.

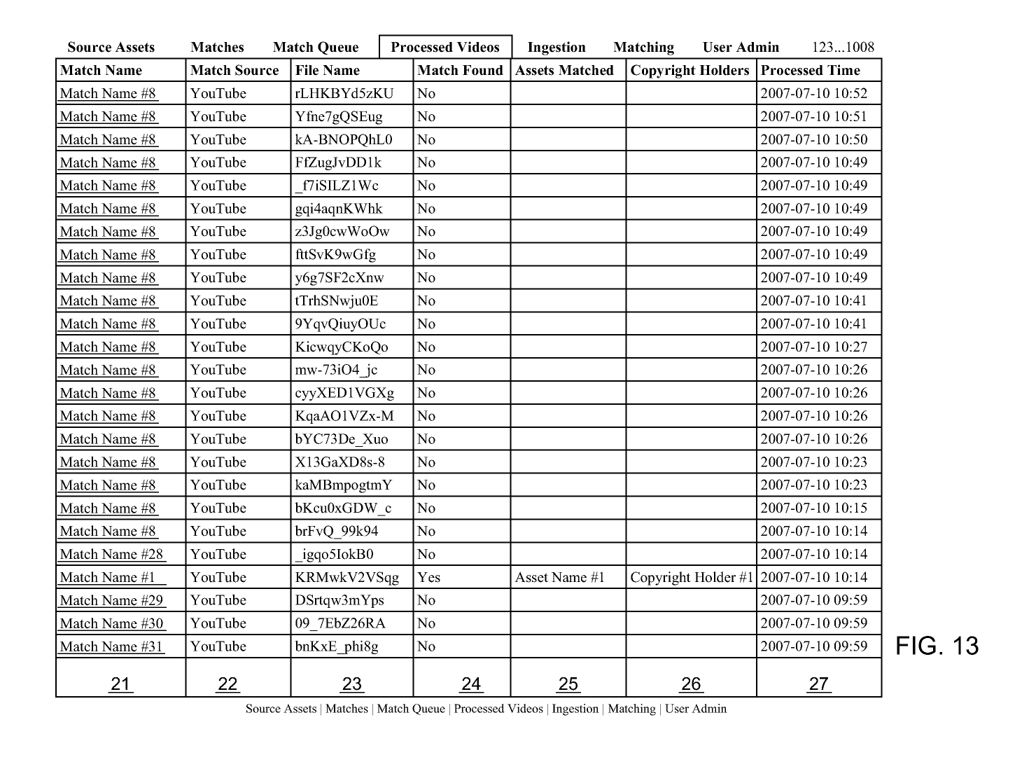

FIG. 13 is an exemplary diagram illustrating match results for the processed inquired content in the match queue from FIG. 11. The column in object 21 comprises the names of the inquired content. The column in object 22 comprises the name of the source or the location of each respective inquired content from object 21. The column in object 23 comprises the file name of each respective inquired content from object 21. The column in object 24 comprises information that illustrates whether each respective inquired content from object 21 was matched with a known content. The column in object 25 comprises the names of the assets or known contents each respective inquired content from object 21 was matched with, if any match was found. The column in object 26 comprises the names of the copyright holders for each respective asset or known content from object 25. The column in object 27 comprises the date and time each respective inquired content was processed for matching.

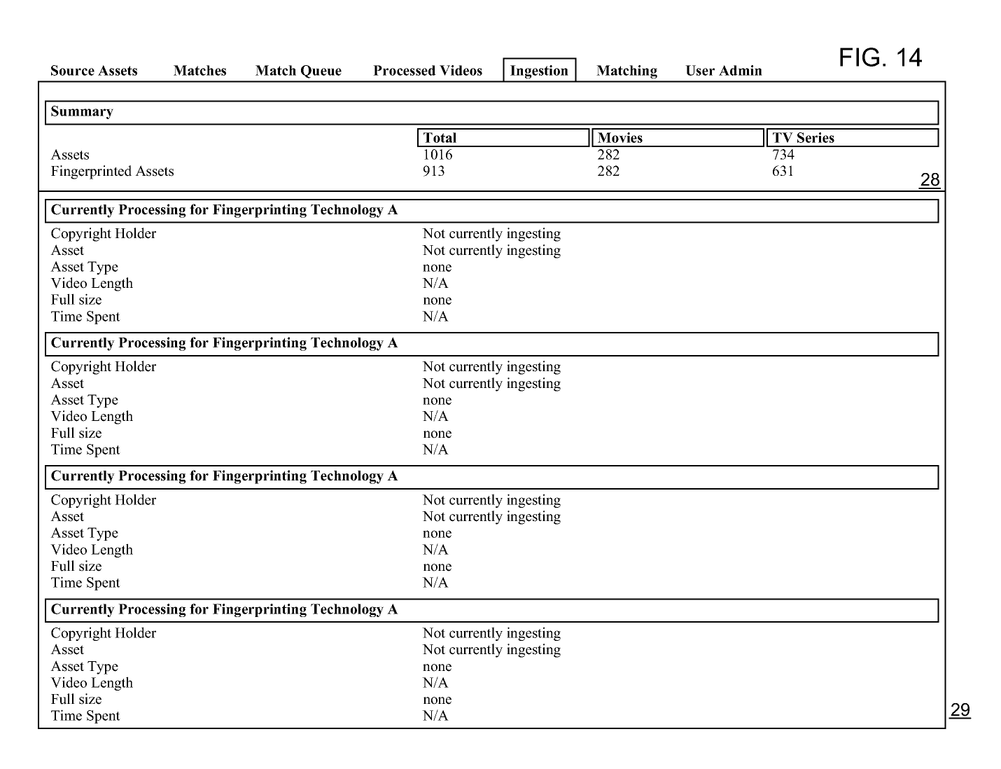

FIG. 14 is an exemplary diagram illustrating an embodiment of a management status and a current ingestion status for the content authentication platform of FIG. 5. The information represented in object 28 illustrates the status of CRTIC processing for the total assets or known contents. The information represented in object 29 illustrates the current status of the ingestion process.

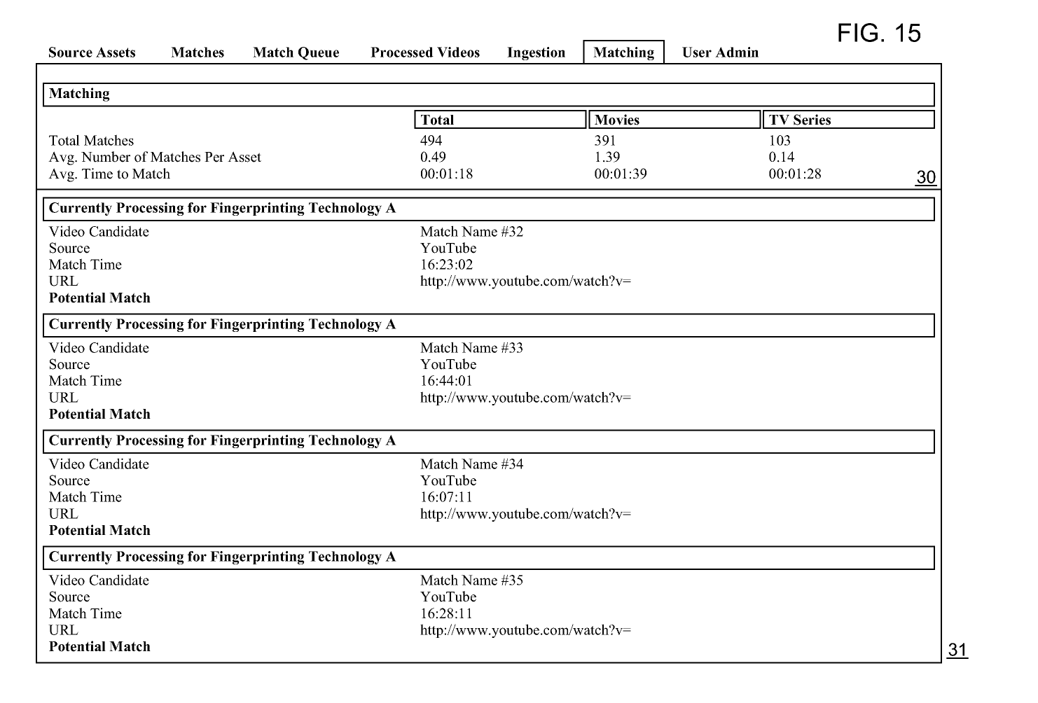

FIG. 15 is an exemplary diagram illustrating an embodiment of a management status and a current matching status for the content authentication platform of FIG. 5. The information represented in object 30 illustrates the status of the number of matches to the total number of assets or known contents. The information represented in object 31 illustrates the current status of the matching process.

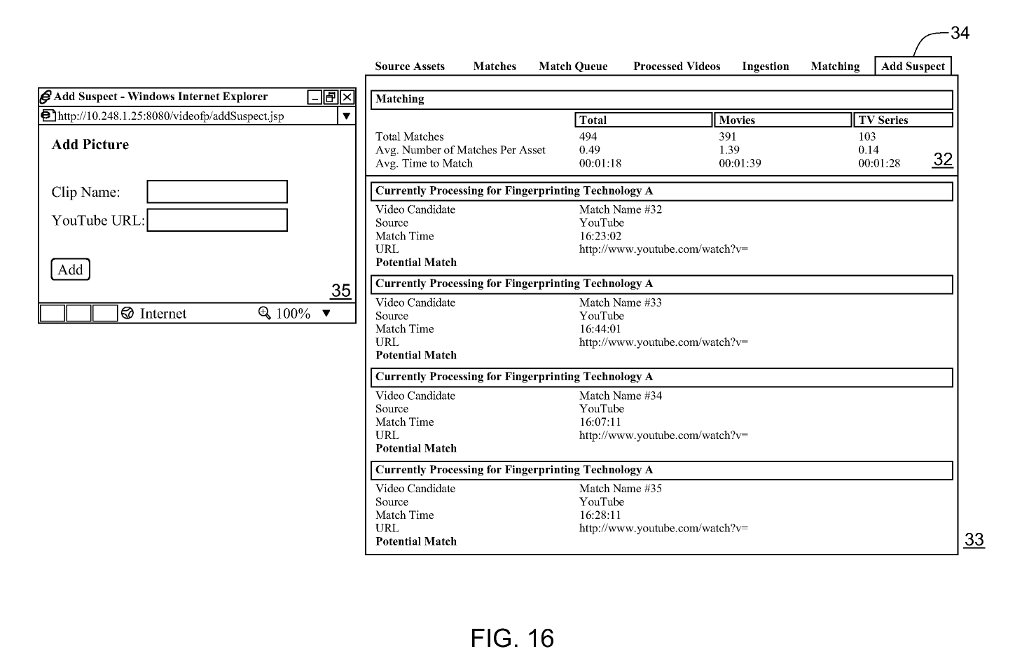

FIG. 16 is an exemplary diagram illustrating an alternative embodiment of the management status and a current matching status for the content authentication platform of FIG. 5. The information represented in object 32 illustrates the status of the number of matches to the total number of assets or known contents. The information represented in object 33 illustrates the current status of the matching process. The management option represented in object 34 allows for the ability to add an inquired content for processing or matching. The management option represented in object 35 allows for the ability to provide descriptive data of the inquired content for processing or matching.

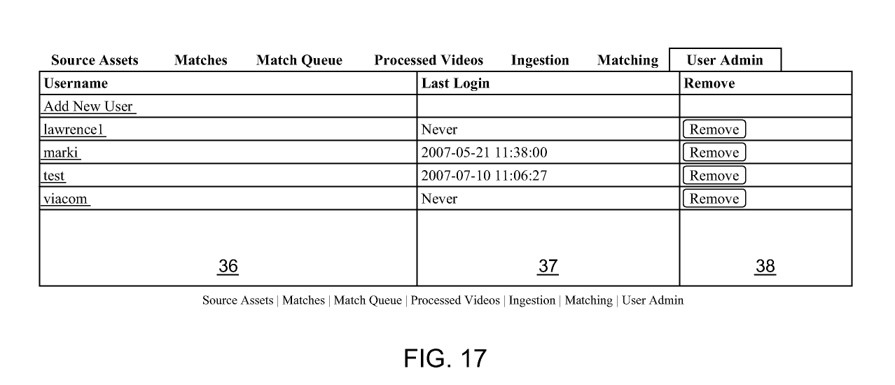

FIG. 17 is an exemplary diagram illustrating an embodiment of an administration status for managing users accessing the content authentication platform of FIG. 5. The column in object 36 comprises the names or login names for users to be managed or be allowed to manage or access a segment or the entire content authentication platform. The column in object 37 comprises data illustrating information about each respective user from object 36, specifically, each user's last login into the system. The column in object 38 comprises the ability to remove each respective user from the ability to manage or be allowed to manage or access any segment of the content authentication platform.

As desired, a partially integrated model can filter non-integrated (or nonparticipating) websites on a post-upload basis by generating shadow indexes for the non-integrated websites. The platform is also able to crawl or scan sites that are not specifically geared to distributing video content. For example, an inquired content or other uploaded media may be posted on a website that is not specifically geared to distributing or posting inquired content. A user of the website may post a link or embed a video from another source (i.e. a video or media website). The platform has the crawling ability to find those instances as well. As desired, a link follower could be incorporated to determine whether an inquired content, which comprises at least a portion of known content, follows, complies with, or obeys the rules of the known content. The link follower may be able to utilize the link or embedded inquired content to determine where the inquired content was originally located. Procedures for following a link or embedded inquired content may differ based on the originating location of the inquired content. Once the link follower has traced the link or embedded inquired content back to the original location, a determination may be made on whether the link or embedded inquired content follows, complies with, or obeys the rules associated with the relevant known content. For example, this could be based on the original location of the inquired content since the original location may be allowed to provide the ability to link or embed the inquired content (based on the rules associated with the known content in the inquired content) to other websites.

The crawling operation set forth above can comprise any conventional type of crawling, such as in the manners set forth in the co-pending U.S. patent application, entitled “System and Method for Confirming Digital Content,”Ser. No. 12/052,967, filed on Mar. 21, 2008, which is assigned to the assignee of the present application and the respective disclosures of which are hereby incorporated herein by reference in its entirety.

As desired, a link follower could be incorporated to determine whether inquired content, which comprises at least a portion of known content, follows, complies with, or obeys the rules of the known content. The disclosed embodiments may also incorporate a crawler with dynamic profile support. The dynamic profile support provides for the ability to utilize the same crawler at any time a new host of content appears. When a new host is recognized or detected, the host's characteristics can be analyzed such that a profile for that host can be created to be utilized by the crawler. The profile could include information for the host such as the domain name and the naming patterns of the host (such as the directory and file name pattern). This dynamic profile support prevents the need to take the system offline, for it will be able to immediately recognize the new host and be able to download content from that new host.

One manner for generating a shadow index can include the use of a Media Indexing Engine (not shown) (or at least one crawler) for downloading existing and newly uploaded media inventory. The Media Indexing Engine preferably searches each non-integrated website repeatedly and using diverse search criteria (or views) to form a substantially complete index for each non-integrated website. The media downloaded through this indexing is processed along the same path as described above with the result of a positive identification of content that is not authorized to be posted on the website generating a takedown notice through the CAP 800. The Media Indexing Engine may also search and index web media sites that participate or are integrated with CAP 800.

Alternatively, and/or in addition, applications can include returning to identified content approved to be uploaded on the site and performing actions that can include collecting metrics for advertising based business models, serving specific advertising related to content, and replacing the actual content with an improved or updated version. Revenue generated from the posting of the content on the site thereby can be allocated among, for example, the content owner and the site owner.

As desired, the CAP 800 can include a video management system (BVM) (not shown) for facilitating the human identification process discussed in more detail above. The BVM is a tool that can be used for human review of a match queue. One primary source of the BVM match queue, as integrated into the CAP 800, is after the decision engine has made preliminary determinations on the action required based on the match result of the identification technologies of the complete match queue. The BVM match queue likewise can be created from other match sources including direct processing of the entire match queue (prior to any processing by identification technologies such as video fingerprinting) or by search results from searches initiated from within the BVM application.

In one preferred embodiment, the BVM catalogs the URL and all available metadata for each video in the match queue in a database system. The BVM presents the URL, metadata, thumbnails and other relevant information in a clear, tabular format to help the user make a specified decision on each video presented. The presentation of the information of each video in the BVM enables the user to drill down and access the source video for detailed inspection to assist in the identification process. A BVM user can make a determination with respect to a particular video, and the BVM can include an interface to catalog this decision in a database system, which is interfaced with the decision engine system 900. The BVM backend can include a full audit trail logging, among other things, the time each decision was made in respect to each video, the username of each person for each decision, and/or the actual decision made. Apart from providing an audit trail, this information can be maintained for process improvement identification and training purposes.

As explained above, the ability to incorporate human review processes is an advantageous aspect of the disclosed embodiments. These processes ensure that one or more CRTIC are performing as intended, and provide a mechanism to handle identifications not previously encountered and accounted for in the processes of the one or more CRTIC. This is especially important in the presence of constant user innovation where new identification problems can be expected. The feedback provided by the human review process can also provide valuable feedback to constantly improve matching accuracy of the one or more CRTIC.

One advantageous aspect of some disclosed embodiments is the ability to provide known content owners or right holders previous instances of inquired content, which may have included at least a portion of their known content. Once inquired content is processed by one or more CRTIC, the inquired content data may be saved such that it could later be compared with or matched to known content data. A known content owner or rights holder could utilize the saved inquired content data to determine past instances of matches between their known content data and inquired content data. As desired, the past instances can be verified to determine whether the past instance of a match still currently exists. As desired, the past instances could be utilized to gather statistical data on usage of known content.

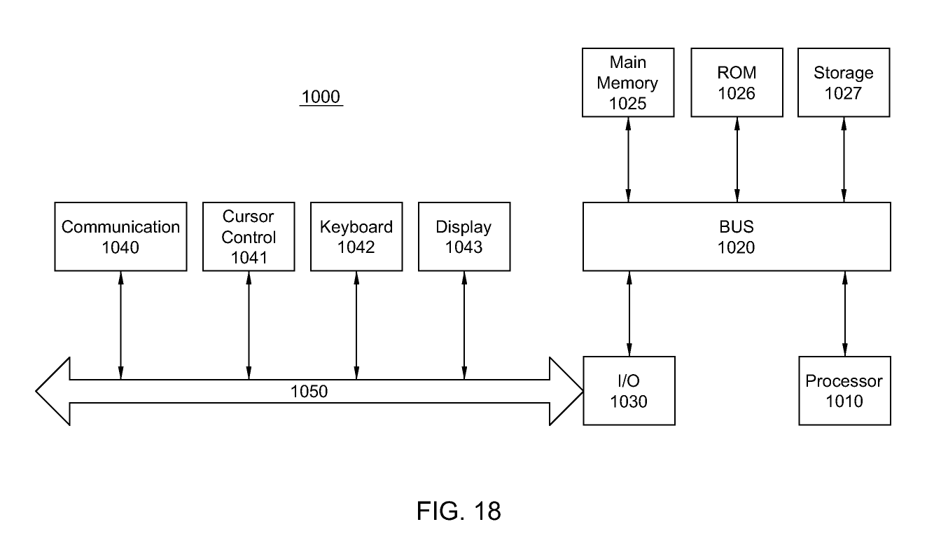

FIG. 18 is an illustration of an exemplary computer architecture for use with the present system, according to one embodiment. Computer architecture 1000 is used to implement the computer systems or data processing systems described in the various embodiments. One embodiment of architecture 1000 comprises a system bus 1020 for communicating information, and a processor 1010 coupled to bus 1020 for processing information. Architecture 1000 further comprises a random access memory (RAM) or other dynamic storage device 1025 (referred to herein as main memory), coupled to bus 1020 for storing information and instructions to be executed by processor 1010. Main memory 1025 is used to store temporary variables or other intermediate information during execution of instructions by processor 101 0. Architecture 1000 can include a read only memory (ROM) and/or other static storage device 1026 coupled to bus 1020 for storing static information and instructions used by processor 101 0.

A data storage device 1027 such as a magnetic disk or optical disk and its corresponding drive is coupled to computer system 1000 for storing information and instructions. Architecture 1000 is coupled to a second I/O bus 1050 via an I/O interface 1030. A plurality of I/O devices may be coupled to I/O bus 1050, including a display device 1043, an input device (e.g., an alphanumeric input device 1042 and/or a cursor control device 1041).

The communication device 1040 is for accessing other computers (servers or clients) via a network (not shown). The communication device 1040 may comprise a modem, a network interface card, a wireless network interface, or other well known interface device, such as those used for coupling to Ethernet, token ring, or other types of networks.

The disclosure is susceptible to various modifications and alternative forms, and specific examples thereof have been shown by way of example in the drawings and are herein described in detail. It should be understood, however, that the disclosure is not to be limited to the particular forms or methods disclosed, but to the contrary, the disclosure is to cover all modifications, equivalents, and alternatives. In particular, it is contemplated that functional implementation of the disclosed embodiments described herein may be implemented equivalently in hardware, software, firmware, and/or other available functional components or building blocks, and that networks may be wired, wireless, or a combination of wired and wireless. Other variations and embodiments are possible in light of above teachings, and it is thus intended that the scope of the disclosed embodiments not be limited by this detailed description, but rather by the claims following.

What is claimed is:

1. A method for determining whether to approve suspect content, comprising:
receiving the suspect content;
performing content recognition on the suspect content to generate suspect content data for the suspect content;
comparing the suspect content data with comparable known content data, the known content data being representative of known content and being associated with one or more known content rules;
finding a correlation between the suspect content data and the known content data;
deciding whether to approve an action for the suspect content based upon said correlation and at least one of the known content rules;
approving the action for the suspect content if the suspect content complies with each of said at least one of the known content rules; and
determining that the suspect content is a misappropriation of the known content if the suspect content does not comply with one or more of said at least one of the known content rules.

2. The method of claim 1, wherein said receiving the suspect content includes at least one of recognizing the suspect content and acknowledging the suspect content.

3. The method of claim 1, wherein said receiving the suspect content comprises receiving inquired content.

4. The method of claim 3, wherein the suspect content data comprises inquired content data for the inquired content.

5. The method of claim 1, wherein said performing content recognition on the suspect content includes at least one of detecting the suspect content data for the suspect content, gathering the suspect content data for the suspect content, creating the suspect content data for the suspect content, applying a content protection technology to the suspect content, performing a content protection technique for identifying the suspect content, and performing a content recognition technique for identifying the suspect content.

6. The method of claim 1, further comprising:
determining whether the suspect content is configured as reconfigured suspect content that complies with each of said at least one of the known content rules; and
if the suspect content can be configured to comply with each of said at least one of the known content rules,
configuring the suspect content to form the reconfigured suspect content; and
approving the action for the reconfigured suspect content.

7. The method of claim 6, wherein said configuring the suspect content includes at least one of altering the suspect content, replacing the suspect content, and providing a license for the known content.

8. The method of claim 1, wherein said finding said correlation between the suspect content data and the known content data includes finding a match between the suspect content data and the known content data.

9. The method of claim 1, further comprising, if suspect content data and known content data are not comparable,
performing a second content recognition on the suspect content to generate a second suspect content data for the suspect content, the second suspect content data being comparable with the known content data;
comparing the second suspect content data with the known content data;
finding a correlation between the second suspect content data and the known content data; and
deciding whether to approve the action for the second suspect content based upon said correlation between the second suspect content data and the known content data and said at least one of the known content rules.

10. A method for authenticating content, comprising:
applying a content recognition technology to known content to generate known content data for the known content, the known content data being associated with at least one known content rule;
comparing the known content data with comparable suspect content data that is representative of suspect content;
determining a correlation between the known content data and the suspect content data;
deciding whether to approve an action for the suspect content based on said determining the correlation and upon a selected known content rule; and
approving the action for the suspect content if the suspect content complies with said selected known content rule.

11. The method of claim 10, further comprising determining that the suspect content is a misappropriation of the known content if the suspect content does not comply with said selected known content rule.

12. The method of claim 10, wherein said comparing the known content data with the comparable suspect content data includes comparing the known content data with inquired content data that is representative of inquired content.

13. The method of claim 10, wherein said applying said content recognition to the known content includes at least one of detecting the known content data for the known content, gathering the known content data for the known content, creating the known content data for the known content, applying a content protection technology to the known content, applying a content protection technique for identifying the known content, and applying a content recognition technique for identifying the known content.

14. The method of claim 10, further comprising:
determining whether the suspect content can be configured as reconfigured suspect content that complies with said selected known content rule; and
if the suspect content can be configured to comply with said selected known content rule,
configuring the suspect content to form the reconfigured suspect content; and
approving the action for the reconfigured suspect content.

15. The method of claim 14, wherein said configuring the suspect content includes at least one of altering the suspect content, replacing the suspect content, and providing a license for the known content.

16. A method for identifying content, comprising:
receiving known content data associated with at least one known content rule, the known content data being generated by applying a content recognition technology to known content;
receiving suspect content data, the suspect content data being generated by applying the content recognition technology to suspect content;
comparing the known content data with the suspect content data;
determining a correlation between the known content data and the suspect content data;
applying said determining the correlation and one or more selected known content rules to decide whether to approve action for suspect content;
approving the action for the suspect content if the suspect content complies with said selected known content rules; and
determining that the suspect content has not been authorized by an owner of the known content if the suspect content does not comply with said selected known content rules.

17. The method of claim 16, wherein receiving the known content data includes at least one of detecting the known content data, recognizing the known content data, and acknowledging the known content data.

18. The method of claim 16, wherein receiving the suspect content data includes at least one of detecting the suspect content data, recognizing the suspect content data, acknowledging the suspect content data and receiving inquired content data that is representative of inquired content.

19. The method of claim 16, wherein said applying said content recognition technology to the known content and the suspect content includes at least one of applying a content protection technology to the known content and the suspect content, applying a content protection technique for identifying the known content and the suspect content, and applying a content recognition technique for identifying the to the known content and the suspect content.

20. The method of claim 16, further comprising:
determining whether the suspect content can be configured as reconfigured suspect content that complies with said with said selected known content rules; and
if the suspect content can be configured to comply with said selected known content rules,
configuring the suspect content to form the reconfigured suspect content; and
approving the action for the reconfigured suspect content.

21. The method of claim 20, wherein said configuring the suspect content includes at least one of altering the suspect content, replacing the suspect content, and providing a license for the known content.

22. The method of claim 16, further comprising:
determining whether the suspect content data and the known content data are comparable; and
if the suspect content data and the known content data are not comparable,
applying a second content recognition on the known content to generate a second known content data for the known content, the second known content data being comparable with the suspect content data;
determining a correlation between the second known content data and the suspect content data; and
applying said determining the correlation between the second known content data and the suspect content data and said selected known content rules to decide whether to approve the action for suspect content.

23. A system for authenticating content, comprising:
a data application system that processes known content associated with at least one known content rule;
a content recognition technology generator that is configured for communication with said data application system, said content recognition technology generator generating known content recognition data associated with the known content, the known content recognition data being comparable to suspect content recognition data associated with suspect content;
a database system that is configured for communication with said data application system and that stores content recognition data; and
a secured communication system that is configured for communication with said data application system and that determines whether a correlation exists between the known content recognition data and the suspect content recognition data, said secured communication system determining whether the suspect content complies with each of said at least one known content rule if the correlation between the known content recognition data and the suspect content recognition data exists,
wherein action for the suspect content is determined to be authorized if the suspect content complies with each of said at least one known content rule.

24. The system of claim 23, wherein the action for the suspect content is determined not to be authorized if the suspect content does not comply with each of said at least one known content rule.

25. The system of claim 23, further comprising a second content recognition technology generator that is configured for communication with said data application system, said content recognition technology generator generating the suspect content recognition data associated with the suspect content.

26. The system of claim 25, wherein said second content recognition technology generator is at least partially integrated with said content recognition technology generator.

27. The system of claim 23, wherein the known content recognition data and the suspect content recognition data each include content protection technology data.

28. The system of claim 23, wherein said content recognition technology generator applies at least one of a content protection technique and a content recognition technique to generate the known content recognition data and the suspect content recognition data.

29. The system of claim 23, further comprising a second content recognition technology generator that is configured for communication with said data application system and that generates second known content recognition data associated with the known content, the second known content recognition data being comparable to the suspect content recognition data, wherein said secured communication system determines whether a correlation exists between the second known content recognition data and the suspect content recognition data.

30. The system of claim 23, further comprising a second content recognition technology generator that is configured for communication with said data application system and that generates second suspect content recognition data associated with suspect content, the second suspect content recognition data being comparable to the known content recognition data, wherein said secured communication system determines whether a correlation exists between the known content recognition data and the second suspect content recognition data.

31. The system of claim 23, wherein said content recognition technology generator provides at least one of the known content recognition data and the suspect content recognition data to said data application system.

32. The system of claim 23, said content recognition technology generator communicates with said database system.

33. The system of claim 32, wherein said content recognition technology generator provides at least one of the known content recognition data and the suspect content recognition data to said database system.

34. The system of claim 23, wherein said data application system provides at least one of the known content recognition data and the suspect content recognition data to said database system.

35. The system of claim 23, wherein said data application system provides at least one of the known content recognition data and the suspect content recognition data to said database system.

36. The system of claim 23, wherein said data application system provides at least one of said at least one known content rule and metadata associated with the known content to said database system.

37. The system of claim 23, wherein said secured communication system determines whether a match exists between the known content recognition data and the suspect content recognition data.

38. The system of claim 23, further comprising a notification system that provides known content information to an owner of the known content.

39. A system for authenticating content, comprising:
a data application system that processes suspect content;
a content recognition generator that generates content recognition data; and
a decision engine that determines whether a correlation exists between suspect content recognition data associated with the suspect content and comparable known content recognition data associated with known content, said decision engine determines whether the suspect content complies with a selected known content rule associated with the known content if said correlation between the suspect content recognition data and the known content recognition data exists,
wherein action for the suspect content is determined to be authorized if the suspect content complies with the known content rule.

40. The system of claim 39, wherein the action for the suspect content is determined not to be authorized if the suspect content does not comply with each of said at least one known content rule.

41. The system of claim 39, wherein said content recognition generator and said decision engine each are in communication with said data application system.

42. The system of claim 39, further comprising a notification system that sends known content information to a holder of the known content.

43. The system of claim 39, further comprising a database system that is configured to communicate with said data application system and that stores content recognition data.

44. The system of claim 43, wherein said content recognition generator provides the content recognition data to said database system.

45. The system of claim 43, wherein said data application system provides the content recognition data to said database system.

46. The system of claim 43, wherein said data application system provides metadata associated with suspect content to said database system.

47. A content identification platform for authenticating content, comprising:
a DarkNet system that receives and stores original source content in a predetermined digital form and that includes a content recognition system that builds a reference identifier for the original source content; and
a ProductionNet system that receives said reference identifier from said DarkNet system and that matches incoming candidate files with said reference identifier based upon at least one predefined matching criteria.

48. The content identification platform of claim 47, wherein said content recognition system includes at least one of a fingerprinting technology system, a watermarking technology system, a content protection technology system, a content protection system, and a content recognition system.

49. The content identification platform of claim 47, wherein said original source content includes known content and wherein said reference identifier includes known content data.

50. The content identification platform of claim 47, wherein said content recognition system builds a candidate file reference identifier for a selected candidate file, said candidate file reference identifier being suitable for comparison with the reference identifier of the original source content.

51. The content identification platform of claim 47, wherein said at least one predefined matching criteria is defined by a right holder of the original source content.

52. The content identification system of claim 47, wherein the DarkNet system is not accessible via an external network.

53. The content identification system of claim 47, wherein the DarkNet system comprises a database system that stores said reference identifier.

54. The content identification system of claim 53, wherein the ProductionNet system includes a database system that receives the reference identifier stored in said database system of said DarkNet system via a secure transfer.

55. The content identification system of claim 54, wherein the secure transfer comprises a physical transfer of a reference identifier file.

56. The content identification system of claim 54, wherein the ProductionNet system associates a secret asset identifier with the reference identifier and includes a content management system that maintains an association between the reference identifier and the secret asset identifier.

57. The content identification platform of claim 56, wherein the secret asset identifier is utilized to identify the original source content.

58. The content identification platform of claim 56, wherein the secret asset identifier is utilized to identify at least one predefined matching criteria, the predefined matching criteria being associated with the original source content.

59. The content identification system of claim 47, wherein the DarkNet system includes a conversion-management system that manages construction of the reference identifier for the original source content.

60. The content identification system of claim 59, wherein the conversion-management system determines when to build the reference identifier.

61. The content identification system of claim 47, wherein the DarkNet system associates descriptive information with the original source content.

62. The content identification platform of claim 47, further comprising a decision engine that utilizes one or more business rules associated with the original source content to perform a predetermined action regarding the matched candidate file.

63. The content identification platform of claim 62, wherein the decision engine communicates information regarding the matched candidate file to a manager for the original source content via a notification system.

64. The content identification platform of claim 62, wherein the information includes at least one of utilization reporting, royalty reporting, and metadata for the candidate file.

65. The content identification platform of claim 64, wherein the metadata includes a candidate file name and a candidate file location of the candidate file.

66. The content identification platform of claim 62, wherein the decision engine provides original source information regarding the original source content to a host of the candidate file.

67. The content identification platform of claim 66, wherein the original source information includes time coded metadata.

68. The content identification platform of claim 47, further comprising a communication system that communicates with one or more websites.

69. The content identification platform of claim 68, wherein said communication system receives a reference identifier for a selected candidate file from a selected website.

70. The content identification platform of claim 68, further comprising a website crawler that searches a selected website to locate a selected candidate file.

71. The content identification platform of claim 68, further comprising a link follower that identifies an original hosting website of a selected candidate file located on at least one of the websites.

72. A system for authenticating content, comprising:
a database system that stores known content data and known content data information associated with the known content data; and
a decision engine that determines whether a correlation exists between known content data and suspect content data and, if said correlation exists, determines whether to approve action for the suspect content if the suspect content complies with the selected known content data information,
wherein the known content data and the suspect content data are generated by applying a content recognition technology to known content and suspect content, respectively.

73. The system of claim 72, wherein the known content data information includes at least one of a business rule and metadata associated with the known content.

74. The system of claim 72, wherein the database system receives the known content data from a DarkNet system.

75. The system of claim 72, wherein said database system receives the known content data via a secure transmission system.

76. The system of claim 72, further comprising a content management system, wherein said database system associates the known content data with a secret asset identifier, and wherein said content management system maintains an association between the known content data and the secret asset identifier.

77. The system of claim 76, wherein the secret asset identifier is utilized identify at least one of the original source content and the known content data information.

78. The system of claim 72, wherein said decision engine provides reporting information regarding said correlation between the known content data and the suspect content data to a manager of the known content.

79. The system of claim 78, wherein the reporting information is communicated to the manager of the known content via a notification system.

80. The system of claim 78, wherein the reporting information includes at least one of utilization reporting, royalty reporting, and metadata for the suspect content.

81. The system of claim 80, wherein the metadata includes a suspect content file name and a suspect content file location associated with the suspect content.

82. The system of claim 72, wherein said decision engine provides the known content data information to a host system of one or more candidate files.

83. The system of claim 82, wherein the known content data information includes time coded metadata.

84. The system of claim 72, further comprising a website crawler that searches a selected website to locate the suspect content.

85. The system of claim 84, further comprising a link follower that identifies the original hosting website of the suspect content.

86. A content authentication platform by identifying content, comprising:
a ProductionNet system that receives known content recognition data and a known content rule each associated with known content, the content recognition data being generated by applying a content recognition technology to the known content; and
a decision engine that finds a correlation between the known content recognition data and suspect content recognition data associated with a suspect content and applies said correlation between the known content recognition data and the suspect content recognition data to determine whether to approve action for the suspect content based on the known content rule, the suspect content recognition data being generated by applying the content recognition technology to the suspect content,
wherein said decision engine determines that the known content has been misappropriated if the suspect content does not comply with the known content rule.

87. The content authentication platform of claim 86, wherein the ProductionNet system associates a secret asset identifier with the known content recognition data and includes a content management system that maintains an association between the known content recognition data and the secret asset identifier.

88. The content identification platform of claim 87, wherein the secret asset identifier identifies the original source content.

89. The content identification platform of claim 86, wherein said decision engine provides reporting information regarding the suspect content data to a manager of the known content.

90. The content authentication platform of claim 86, wherein the reporting information is communicated to the manager of the known content via a notification system.

91. The content authentication platform of claim 86, wherein the reporting information includes at least one of utilization reporting, royalty reporting, and metadata for the suspect content.

92. The content authentication platform of claim 91, wherein the metadata includes a suspect content file name and a suspect content file location associated with the suspect content.

93. The content identification platform of claim 86, further comprising a website crawler that searches a selected website to locate a selected candidate file.

94. The content identification platform of claim 93, further comprising a link follower that identifies an original hosting website of the selected candidate file.

95. A computer program product suitable for storage on a physical storage medium and having computer-readable instructions, the computer program product comprising:
an instruction that receives the suspect content;
an instruction that performs content recognition on suspect content to generate suspect content data for the suspect content;
an instruction that compares the suspect content data with comparable known content data that is representative of known content and that is associated with at one or more known content rules;
an instruction that finds a correlation between the suspect content data and the known content data; and
an instruction that decides whether to approve action for the suspect content based upon said correlation between the suspect content data and the known content data and at least one selected known content rule,
wherein action for the suspect content is determined to be authorized if the suspect content complies with said at least one selected known content rule, and
wherein the suspect content is determined to be a misappropriation of the known content if the suspect content does not comply with one or more of said at least one of the known content rules.

96. The computer program product of claim 95, wherein said instruction that receives the suspect content includes at least one of an instruction that recognizes the suspect content, an instruction that acknowledges the suspect content, and an instruction that receives inquired content.

97. The computer program product of claim 95, wherein said instruction that performs said content recognition on the suspect content includes at least one of an instruction that detects the suspect content data for the suspect content, an instruction that gathers the suspect content data for the suspect content, an instruction that creates the suspect content data for the suspect content, an instruction that applies a content protection technology to the suspect content, an instruction that applies a content protection technique to identify the suspect content, and an instruction that applies a content recognition technique to identify the suspect content.

98. The computer program product of claim 95, further comprising:
an instruction that determines whether the suspect content can be configured as reconfigured suspect content that complies with each of said at least one selected known content rule; and
an instruction that configures the suspect content to form the reconfigured suspect content and an instruction that approves the action for the reconfigured suspect content each if the suspect content can be configured to comply with each of said at least one selected known content rule.

99. The computer program product of claim 95, wherein said instruction that configures the suspect content includes at least one of an instruction that alters the suspect content and an instruction that replaces the suspect content, and an instruction that provides a license for the known content.

100. The computer program product of claim 95,
an instruction that performs a second content recognition on the suspect content to generate a second suspect content data for the suspect content if suspect content data and known content data are not comparable, the second suspect content data being comparable with the known content data;
an instruction that compares the second suspect content data with the known content data;
an instruction that finds a correlation between the second suspect content data and the known content data; and
an instruction that decides whether to approve the action for the second suspect content based upon said correlation between the second suspect content data and the known content data and said at least one of the known content rules.

101. A computer program product suitable for storage on a physical storage medium and having computer-readable instructions, the computer program product comprising:
an instruction that applies a content recognition technology to known content to generate known content data for the known content, the known content data being associated with at least one known content rule;
an instruction that compares the known content data with comparable suspect content data that is representative of suspect content;
an instruction that determines a correlation between the known content data and the suspect content data; and
an instruction that decides whether to approve action for the suspect content based on said correlation and a selected known content rule,
wherein the action for the suspect content is determined to be authorized if the suspect content complies with said at least one selected known content rule.

102. The computer program product of claim 101, further comprising an instruction that determines that the action for the suspect content is determined not to be authorized if the suspect content does not comply with each of said at least one known content rule.

103. The computer program product of claim 101, wherein said instruction that applies said content recognition technology to the known content includes at least one of an instruction that detects the known content data for the known content, an instruction that gathers the known content data for the known content, an instruction that creates the known content data for the known content, an instruction that applies a content protection technology to the known content, an instruction that applies a content protection technique to identify the known content, and an instruction that applies a content recognition technique to identify the known content.

104. The computer program product of claim 101, further comprising:
an instruction that determines whether the suspect content can be configured as reconfigured suspect content that complies with each of said at least one of the known content rules; and
an instruction that configures the suspect content to form the reconfigured suspect content and an instruction that approves the action for the reconfigured suspect content each if the suspect content can be configured to comply with each of said at least one of the known content rules.

105. The computer program product of claim 101, wherein said instruction that configures the suspect content includes at least one of an instruction that alters the suspect content and an instruction that replaces the suspect content, and an instruction that provides a license for the known content.

106. The computer program product of claim 101,
an instruction that performs a second content recognition on the suspect content to generate a second suspect content data for the suspect content if suspect content data and known content data are not comparable, the second suspect content data being comparable with the known content data;
an instruction that compares the second suspect content data with the known content data;
an instruction that determines a correlation between the second suspect content data and the known content data; and
an instruction that decides whether to approve the action for the second suspect content based upon said correlation between the second suspect content data and the known content data and said at least one of the known content rules.
